(19) United States
(12) Patent Application Publication
(10) Pub. No.: US 2025/0233555 A1
(43) Pub. Date: Jul. 17, 2025

(54) Snow Removal Method for Solar Tracker Installation

(71) Applicant: OMCO SOLAR, LLC, Phoenix, AZ (US)

(72) Inventors: Matt Kesler, Phoenix, AZ (US); Steve Ouandji, Goodyear, AZ (US); Lepolve Varpilah, Queen Creek, AZ (US)

(21) Appl. No.: 19/030,894

(22) Filed: Jan. 17, 2025

Related U.S. Application Data
(60) Provisional application No. 63/621,890, filed on Jan. 17, 2024.

(51) Int. Cl. H02S 40/12; H02S 20/32

(52) U.S. Cl. CPC H02S 40/12; H02S 20/32

(57) ABSTRACT

A method of snow removal for a plurality of solar tracker assemblies. The steps of the method include: a) determining at least one current snow presence variable value associated with the solar tracker installation; b) determining at least one other current variable value associated with the solar tracker installation selected from one or more of the following variable categories: 1) a weather condition variable category; 2) a temporal variable category; 3) a weather prediction variable category; and 4) a snow removal routine variable category; c) applying the decision rule to determine if the at least one current snow presence variable value and the least one other current variable value correspond to a snow removal condition; and d) if the decision rule determines that the current variable values correspond to a snow removal condition, executing the snow removal routine for a set of the plurality of solar tracker assemblies.

### CROSS REFERENCE TO RELATED APPLICATIONS

The following application claims priority under 35 U.S.C. § 119(e) to co-pending U.S. Provisional Patent Application Ser. No. 63/621,890, filed Jan. 17, 2024, entitled Snow Removal Method For Solar Tracker Installation. The above-identified U.S. provisional patent application is incorporated by reference herein in its entirety for any and all purposes.

### TECHNICAL FIELD

The present disclosure relates to an apparatus and method for monitoring snow accumulation on upper surfaces of a plurality of photovoltaic modules mounted to a pivoting table of a single axis solar tracker assembly, applying a decision rule to determine if a snow removal function or routine should be initiated to dump or remove snow from the upper surfaces of the plurality of photovoltaic modules, and, if the decision rule determines that the snow removal function should be executed, executing the snow removal function including pivoting the table of the solar tracker assembly to remove accumulated snow from the upper surfaces of the plurality of photovoltaic modules of the solar tracker assembly.

### BACKGROUND

A large-scale solar tracker installation may include hundreds or thousands of horizontal, single axis solar tracker systems or assemblies on an installation site. Each solar tracker assembly includes a pivoting or rotatable table which is driven by a drive mechanism such that the solar tracker assembly table is rotated or pivoted through a predetermined angle of inclination range to track the position of the sun as the sun moves across the sky from east to west. The table of each solar tracker assembly includes a torque tube beam, which may be hundreds of feet in length and is oriented in a north-south direction. The torque tube beam supports a plurality of photovoltaic modules which are affixed along an extent of the torque tube beam via a plurality of mounting brackets. The torque tube beam, in turn, is rotatably supported by a plurality of rotatable bearing assemblies positioned at spaced apart locations along the torque tube beam.

The drive mechanism of the solar tracker assembly provides for precise pivoting or rotational movement of the table and, thereby, the angle of inclination of the table. The drive mechanism, in turn, operates under the control of a solar tracker controller associated with the solar tracker assembly. During daylight time periods or daylight hours, the solar tracker controller, via the drive mechanism, controls the angle of inclination of the table of its associated solar tracker assembly to point the upper surfaces of the plurality of photovoltaic modules at the sun as the sun moves across the sky from east to west. At night, that is, non-daylight hours, the solar tracker controller, via the drive mechanism, moves the table angle of inclination to a night stow position. Under certain abnormal weather conditions, such as windy conditions or overcast conditions, the solar tracker controller will change the table angle of inclination to protect the plurality of photovoltaic modules from potential damage and/or increase energy output. For example, during high wind conditions, the solar tracker controller may direct the drive mechanism to pivot the table to a wind stow position to minimize wind stress on the plurality of photovoltaic modules and other components of the table of the solar tracker assembly.

Another weather condition that requires attention by solar tracker assembly designers is snow, specifically, snow accumulation on the upper surfaces of the plurality of photovoltaic modules of the table of a solar tracker assembly. A snow accumulation condition can cause difficulty in at least two ways. First, snow is very reflective and even a thin layer of snow decreases the incidence of sunlight on the upper, light receiving surfaces of the plurality of photovoltaic modules during daylight hours. The snow layer decreases the energy output of the solar tracker assembly. Even a thin layer of snow on the upper surfaces of the plurality of photovoltaic modules of the table of a solar tracker assembly may reduce energy production by 50% or more. Thus, to the extent possible, when snow accumulation is sensed on the upper surfaces of the photovoltaic modules, a snow removal or snow dump routine should be initiated to pivot the table in an attempt to remove the snow layer from the upper surfaces of the photovoltaic modules. A second issue with snow accumulation is that it adds extra, undesirable weight to the table of the solar tracker assembly. This additional weight, if sufficient, could excessively bow and thereby damage the photovoltaic modules. The additional weight also stresses other components of the solar tracker assembly including the mounting brackets that support the plurality of photovoltaic modules and a drive mechanism that pivots the table through an angle of inclination range thereby requiring increased maintenance and early replacement of components of the solar tracker assembly.

Photovoltaic modules vary widely in their ability to withstand weight on their upper surfaces. Some photovoltaic modules may be designed to withstand up to 20 pounds per square foot (psf), while other photovoltaic modules may be designed to withstand 40 psf or more. Solar tracker assemblies of large-scale solar tracker installation may utilize different photovoltaic modules having a range of psf design values. Depending on atmospheric conditions, snow can weigh as little as one pound per cubic foot or as much as 20 pounds per cubic foot. Snow which has been subject to varying temperatures, sun and/or wind conditions tends to be more dense than newly fallen snow. Accordingly, the weight of snow that can be safely supported by a particular set of photovoltaic modules of a given solar tracker assembly may vary considerably over the solar tracker assemblies of a solar tracker installation. As such, solar tracker installations in snowy regions have a need for a snow removal routine or function that effectively deal with snow accumulation on the upper surfaces of photovoltaic modules of the solar tracker assemblies of the installation both for reasons of energy reduction resulting from snow reflectance and the damage and maintenance issues resulting from snow weight.

However, instituting a snow removal routine or function is not without cost. Executing a snow removal routine which may include a predetermined pivoting of the tables of the solar tracker assemblies of the solar tracker installation in an effort to remove snow accumulation on the upper surfaces of the photovoltaic module, if executed during daylight hours, requires a deviation from the normal solar tracking mode, that is, a deviation from the normal solar tracker mode table angle of inclinations that the solar tracker assemblies would otherwise be at so as to be aiming at the current position of the sun. Executing a snow removal routine and pivoting of the tables of the solar tracker assemblies during daylight hours would necessarily reduce energy output of the solar tracker assemblies during the duration of the snow removal routine.

Even during non-daylight hours, execution of a snow removal routine requires energy. For example, in an installation where the solar tracker controllers are DC powered by a battery pack, executing a snow removal routine requires energy from the controller battery pack. During non-daylight hours, the battery pack cannot be charged, thus, there would be a concern that if a controller battery pack is depleted to an extent where no further pivoting of the associated table is possible, the table could not be pivoted, for example, to a wind stow position in the event of a high wind condition during the period of battery depletion. A DC powered solar tracker controller is described in U.S. non-provisional patent application Ser. No. 18/527,134, filed Dec. 1, 2023, entitled DC Powered Solar Tracker Controller With Heated Battery, to Kesler et al. application Ser. No. 18/527,134 is assigned to the assignee of the present invention and is incorporated by reference herein for any and all purposes. Thus, if a sufficiently large snow layer has not accumulated on the upper surfaces of the photovoltaic modules of the solar tracker assemblies of the solar tracker installation, it is undesirable to institute a snow removal routine or function when it is not warranted. Accordingly, there is a continuing desire to improve both snow sensing and providing improved decision rules regarding when to institute a snow removal routine for the solar tracker assemblies of such solar tracker installations.

### SUMMARY

In one aspect, the present disclosure relates to a method of snow removal from upper surfaces of photovoltaic modules mounted to pivoting tables of a plurality of solar tracker assemblies of a solar tracker installation based on a plurality of input variable values and application of a decision rule to determine if a snow removal routine is appropriate, the steps of the method comprising: a) determining at least one current snow presence variable value associated with the solar tracker installation; b) determining at least one other current variable value associated with the solar tracker installation selected from one or more of the following variable categories: 1) a weather condition variable category; 2) a temporal variable category; 3) a weather prediction variable category; and 4) snow removal routine variable category; c) applying the decision rule to determine if the at least one current snow presence variable value and the least one other current variable value correspond to a snow removal condition; and d) if the decision rule determines that the at least one current snow presence variable value and the least one other current variable value correspond to a snow removal condition, executing the snow removal routine for a set of the plurality of solar tracker assemblies of the solar tracker installation.

In another aspect, the present disclosure relates to a method of snow removal from upper surfaces of photovoltaic modules mounted to pivoting tables of a plurality of solar tracker assemblies of a solar tracker installation utilizing a snow removal routine, execution of the snow removal routine based on a plurality of input variable values, the steps of the method comprising: a) determining a snow depth variable value associated with the solar tracker installation, the snow depth variable value representative of a depth of accumulated snow on the upper surfaces of the photovoltaic modules; b) determining at least one other current variable value associated with the solar tracker installation; c) setting a lower threshold value and an upper threshold value, the upper threshold value being greater in magnitude than the lower threshold value; d) applying a decision rule to determine if a snow removal condition exists: 1) the decision rule finding a snow removal condition exists if the snow depth variable value is equal to or greater than the upper threshold value regardless of a current value of the at least one other current variable value; and 2) the decision rule finding a snow removal condition exists if the snow depth variable value is equal to or greater than the lower threshold value and less than the upper threshold value and if the current value of the at least one other current variable value has a predetermined snow condition value; and e) if the decision rule determines that a snow removal condition exists, executing the snow removal routine for a set of the plurality of solar tracker assemblies of the solar tracker installation and executing the snow removal routine for a set of the solar tracker assemblies of the solar tracker installation.

In another aspect, the present disclosure relates to a method of snow removal from upper surfaces of photovoltaic modules mounted to pivoting tables of a plurality of solar tracker assemblies of a solar tracker installation based on a plurality of input variable values and application of a decision rule to determine if a snow removal routine is appropriate, the steps of the method comprising: a) determining at least two current variable values associated with the solar tracker installation selected from one or more of the following variable categories: 1) a weather condition variable category; 2) a temporal variable category; 3) a weather prediction variable category; and 4) a snow removal routine variable category; b) applying a transformation function to the at least two current variable values to generate a current condition status word; c) applying the decision rule to determine if the current condition status word corresponding to a snow removal condition; d) if the decision rule determines that the current snow condition status word corresponds to a snow removal condition, executing the snow removal routine for a set of the plurality of solar tracker assemblies of the solar tracker installation; and e) updating what variables should be included in a current condition status word based on analysis of a correlation between previous current condition status words corresponding to a snow removal condition and corresponding snow removal routine result variable values.

In another aspect, the present disclosure relates to a method of snow removal from upper surfaces of photovoltaic modules mounted to pivoting tables of a plurality of solar tracker assemblies of a solar tracker installation based on a plurality of input variable values and application of a decision rule to determine if a snow removal routine is appropriate, the steps of the method comprising: a) determining at least two current variable values associated with the solar tracker installation selected from one or more of the following variable categories: 1) a weather condition variable category; 2) a temporal variable category; 3) a weather prediction variable category; and 4) a snow removal routine variable category; b) applying a transformation function to the at least two current variable values to generate a current condition status word; c) applying the decision rule to determine if the current condition status word corresponding to a snow removal condition; and d) if the decision rule determines that the current snow condition status word corresponds to a snow removal condition, executing the snow removal routine for a set of the plurality of solar tracker assemblies of the solar tracker installation.

In another aspect, the present disclosure relates to a method of snow removal from upper surfaces of photovoltaic modules mounted to pivoting tables of a plurality of solar tracker assemblies of a solar tracker installation located on a solar tracker installation site utilizing a snow removal routine, the steps of the method comprising: a) setting a snow depth threshold value; b) periodically determining a snow depth variable value representative of a depth of accumulated snow on the upper surfaces of the photovoltaic modules of one or more of the plurality of solar tracker assemblies; c) periodically determining a snowing condition variable value representative of whether or not it is currently snowing at the solar tracker installation site; d) applying a decision rule to determine if a snow removal condition exists, the decision rule determining a snow removal condition exists if the snow depth variable value is equal to or greater than the snow depth threshold value and if the snowing condition variable value has a value indicating that it is not currently snowing at the solar tracker installation site; and e) if the decision rule determines that a snow removal condition exists, executing the snow removal routine for a set of the plurality of solar tracker assemblies of the solar tracker installation.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is a schematic top perspective view of a solar tracker installation including a plurality of a single row, horizontal, single axis solar tracker assemblies on a solar tracker installation site, the solar tracker installation including a set of solar tracker assemblies including adjacent, aligned rows of spaced apart solar tracker assemblies, the solar tracker installation further including a plurality of weather sensors for measuring snow presence variable values corresponding to snow presence on upper surfaces of a plurality of photovoltaic modules of one or more solar tracker assemblies of the solar tracker installation site and measuring weather condition variable values at the solar tracker installation site;

FIG. 2 is a schematic bottom perspective view of a portion of a representative single row, horizontal, single axis solar tracker assembly of the plurality of solar tracker assemblies of the solar tracker installation of FIG. 1, including a solar tracker controller associated with the solar tracker assembly operatively coupled to a drive mechanism of the solar tracker assembly, the solar tracker controller actuating the drive mechanism to change the angle of inclination of the pivoting table of the solar tracker assembly, the solar tracker controller including a dedicated photovoltaic module for providing DC power to the solar tracker controller;

FIG. 3 is a schematic top perspective view of a portion of the solar tracker assembly of FIG. 2, for simplicity and to facilitate viewing of other components of the solar tracker assembly, only select components of the solar tracker assembly, including a single representative photovoltaic module of the plurality of photovoltaic modules of the solar tracker assembly supported by the frame is depicted in FIG. 3;

FIG. 4 is a schematic top plan view of the solar tracker assembly of FIG. 2;

FIG. 5 is a schematic vertical section view of the solar tracker assembly of FIG. 2, as seen from a plane indicated by the line 5-5 in FIG. 4, the solar tracker assembly including a table mounted weather sensor, a second post mounted weather sensor is also schematically depicted;

FIG. 6 is a simplified flow diagram of selected steps of an example embodiment of a method of snow removal of the present disclosure;

FIGS. 7A and 7B are a simplified flow diagram of selected steps of an example embodiment of a method of snow removal of the present disclosure including a listing of potential input variables to the method of snow removal;

FIG. 8 is a simplified flow diagram of a machine learning process used in conjunction with the method of snow removal to improve the performance of the method of snow removal based on analysis of success/failure of prior executed snow removal routines with respect to successfully removing accumulated snow from upper surfaces of the plurality of photovoltaic modules of a solar tracker assembly; and

FIG. 9 is a simplified diagrammatic representation of a first snow removal model of the method of snow removal, the model utilizing an if-then decision tree;

FIG. 10 is a simplified diagrammatic representation of a second snow removal model of the method of snow removal, the model utilizing a decision matrix or chart; and

FIG. 11 is a simplified diagrammatic representation of a third snow removal model of the method of snow removal, the model utilizing a binary status word comparison.

### DETAILED DESCRIPTION

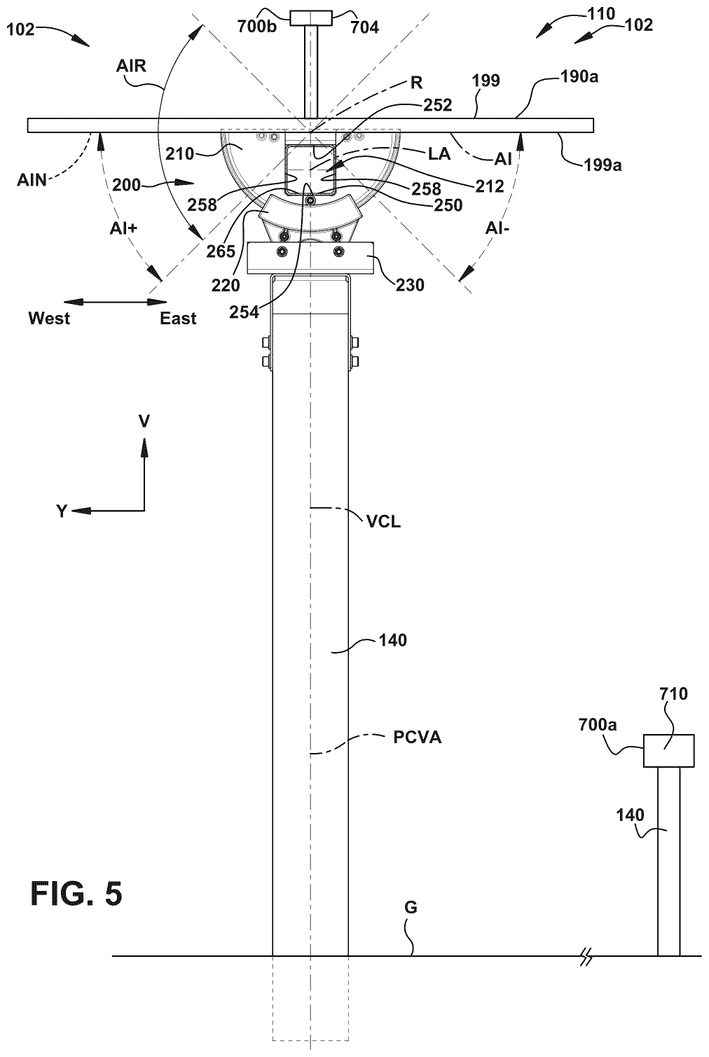

The present disclosure relates to a method of snow removal 2000 for use in connection with a plurality of single axis solar tracker assemblies 100 of a solar tracker installation 1000 located on an installation site 1002. Each of the plurality of solar tracker assemblies 100 of the installation 1000, for example, representative solar tracker assembly 100, operates under the control of an associated solar tracker controller, for example, representative solar tracker controller 602 of a plurality of solar tracker controllers 600. Each of the solar tracker assemblies 100 includes a plurality of photovoltaic modules 190 mounted to a table 110 that pivots, under the control of an associated solar tracker controller, for example, representative solar tracker controller 602 of the plurality of solar tracker controllers 600, to follow the position of the sun as the sun moves from east to west across the sky during daylight hours. The table 110 is pivoted under the control of the solar tracker controller 602 through an angle of inclination range AIR, that is, the solar tracker controller 602 sends control signals to a drive mechanism 150 of the solar tracker assembly 102 to change an angle of inclination AI of the table 110 of the solar tracker assembly 102. In one example or exemplary embodiment, the angle of inclination range AIR of the table 110 is 120 degrees, that is, a range of −60 degrees from a horizontal or neutral angle of inclination AIN (wherein the upper or sun facing surfaces 199 of the plurality of photovoltaic modules 190 of the table 110 are angled to face in an easterly direction toward the morning sun rising in the east) to +60 degrees (wherein the upper or sun facing surfaces 199 of the plurality of photovoltaic modules 190 of the table 110 are angled to face in a westerly direction toward the evening sun setting in the west). A maximum negative angle of inclination of the table 110 is referred to herein as AI− (facing east—FIG. 5), while a maximum positive angle of inclination of the table 110 is referred to herein as AI+ (facing west—FIG. 5).

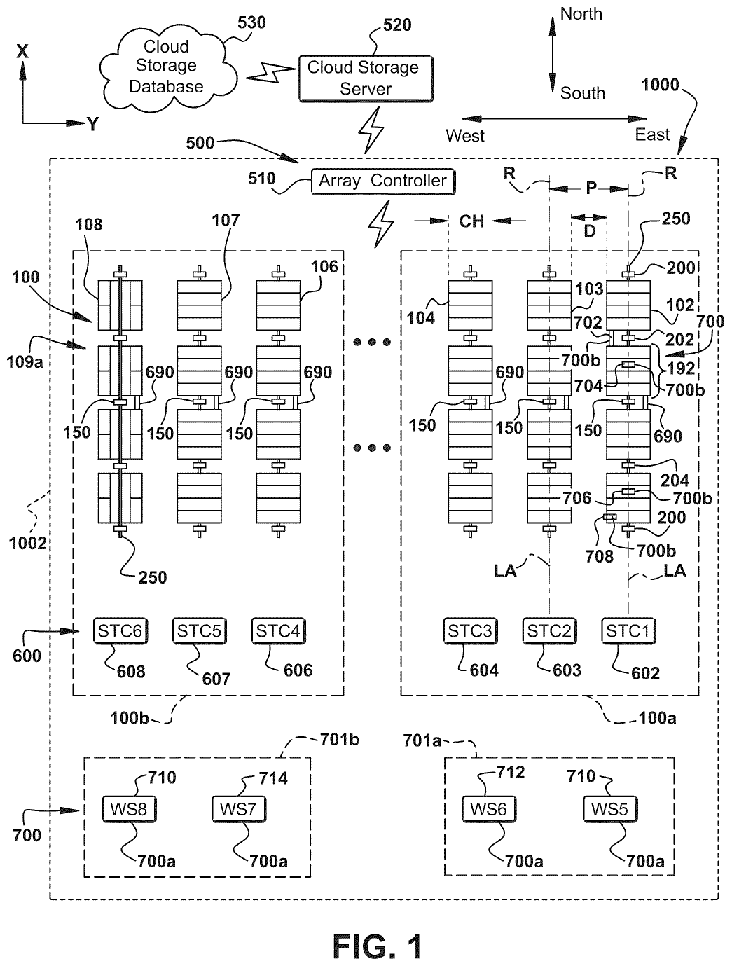

Additionally, the solar tracker installation 1000 includes a plurality of weather sensors 700, certain weather sensors, for example weather sensors 700b may be mounted to pivoting tables 100 of one or more of the solar tracker assemblies 100, while other weather sensors, for example, weather sensors 700a may be mounted to support posts 140 in proximity to, but not mounted on, the solar tracker assembly 110. Certain of the plurality of weather sensors 700, for example, weather sensors 710, 712, 714, 716 are mounted on support posts 140 and are stationary, stand-alone weather sensors 700a (FIGS. 1 and 5), while other weather sensors of the plurality of weather sensors 700 are mounted on and pivot with a table 110 of a solar tracker assembly, for example, the representative solar tracker assembly 102, which will be used for explanation purposes herein, although recognizing that a particular table-mounted weather sensor, e.g., table mounted weather sensors 702, 704, 706, 708 (FIGS. 1, 4 and 5), may be mounted on any of the tables 110 of any of the plurality of solar tracker assemblies 100. Additionally, it should be understood that in the solar tracker installation 1000 there may be several weather sensors 700 of the same type such that multiple measurements of the same weather condition variable may be made for purposes of generating an average value of the measured weather condition variable and/or for redundancy purposes, in the event a given weather sensor malfunctions.

In one example embodiment, the plurality of solar tracker controllers 600 are part of the wireless solar tracker control and communications system 500 of the solar tracker installation 1000. The control and communications system 500 advantageously employs a long-range, radio frequency, sub GHz, wireless data communications protocol and a star wireless communications network configuration to allow for centralized control of the installation 1000 by the central processor/controller or array controller 510 and provide for efficient, wireless transmission of data and control signals between the array controller 510, the plurality of solar tracker controllers 600, and the plurality of weather sensors 700. The array controller 510 receives wireless communications from the plurality of weather sensors 700 regarding weather-related data and receives wireless communications from the plurality of solar tracker controllers 600 regarding operating and maintenance data of the associated plurality of solar tracker assemblies 100. The array controller 510, in turn, wirelessly communicates control signals to each of the plurality of solar tracker controllers 600, for example, solar tracker controller 602, to control one or more of the following: a) the current operating mode of the solar tracker assembly 102 (is the solar tracker assembly 102 in a normal tracking mode, night mode, high wind condition mode, snow removal mode (i.e. execution of a snow removal routine or function 2100), etc.); and/or b) the angle of inclination AI of the table 110 of the solar tracker assembly 102. Additionally, the control and communications system 500 additionally includes storage of selected data regarding operation and maintenance of the solar track installation 1000, allowing for remote, real-time access to stored operating and maintenance data by owners/operators of the solar tracker installation 1000 via smart devices. Additionally, the array controller 510 receives weather condition data from each of the plurality of weather sensors 700 of the solar tracker installation 1000. In one exemplary embodiment, the array controller 510 stores operating and maintenance data received from each of the plurality of solar tracker controllers 600 and weather condition data received from each of the plurality of weather sensors 700 in a cloud storage database 530 utilizing a cloud storage server 520, which may be remote from the installation site 1002. Communications from the array controller 510 to the cloud storage server 520 may be via a router (which is part of electronics of the array controller 510) or via a cellular network. Additional details of the solar tracker control and communications system 500 suitable for a large-scale solar tracker installation are disclosed in U.S. Pat. No. 11,955,925 to Kesler et al., issued Apr. 9, 2024, and entitled Large-Scale Solar Tracker Installation Control System. U.S. Pat. No. 11,955,925 is assigned to the assignee of the present application and is incorporated by reference herein in its entirety.

### Overview—Method Of Snow Removal 2000

The method of snow removal 2000 of the present disclosure seeks to satisfy two different, but related, objectives: a) removing accumulated snow from the upper surfaces 199 of the plurality of photovoltaic modules 190 of each of the plurality of solar tracker assemblies 100 of the solar tracker installation 1000 to maximize solar energy generation by the photovoltaic modules 190 of the installation; and b) removing accumulated snow from the upper surfaces 199 of the plurality of photovoltaic modules 190 to prevent damage to components of the tables 110 (including the photovoltaic modules 190 and a frame 120 supporting the photovoltaic modules 190, which are components of the table 110) of each of the plurality of solar tracker assemblies 100 of the installation 1000 and/or premature wear of the components of the drive mechanisms 150 of the solar tracker assemblies 100. As noted previously, even a thin layer of snow on the upper surfaces 199 of the plurality of photovoltaic modules 190 will reflect a portion of the sunlight incident on the upper surfaces of the plurality of photovoltaic modules 190 and thereby reduce energy generation. That is, a 0.1 inch depth layer of snow on the upper surface 199 of a photovoltaic module 190 may reduce energy production from the module by 50% or more.

The method of snow removal 2000 of the present disclosure includes two main functions: a) deciding when to execute a snow removal routine or function 2100 to remove accumulated snow from the upper surfaces 199 of the plurality of photovoltaic modules 190 of the plurality of solar tracker assemblies 100 of the solar tracker installation 1000 (referred to herein as the snow removal decision); and b) execution of the snow removal routine 2100, that is, the specific pivoting motion of the tables 110 utilized during execution of the snow removal routine 2100. For example, if the table 110 of a specific solar tracker assembly 102 of the installation 1000 has a photovoltaic module configuration of one-in-portrait, the snow removal routine 2100 would move or pivot the table 110 to either the maximum or minimum table angles of inclination AI+or AI−, pause for snow dumping, and then resume normal tracking. The snow removal routine 2100 alternates between using the maximum and minimum table angles of inclination AI+, AI− to distribute the dumped snow relatively evenly on both sides of the solar tracker assembly 102. By contrast, if the table 110 of a specific solar tracker assembly 102 of the installation 1000 has a photovoltaic module configuration of two-in-landscape, the snow removal routine 2100 would move or pivot the table 110 to AI− (maximum pivot—facing east), pause for snow dumping, then move the table 110 to AI+ (maximum pivot—facing west), pause for snow dumping, then resume normal tracking. That is, the tables 110 are first pivoted to the maximum negative angle of inclination AI− (east), then subsequently, the tables 110 are pivoted to the minimum negative angle of inclination AI+ (west). By virtue of this double pivot movement, the accumulated snow will slide off of the upper surfaces 199 of the plurality of photovoltaic modules 190 from each of the two rows of photovoltaic modules 190 in the two-in-landscape configuration. In one example embodiment, the snow removal routine 2100 may be implemented by temporarily changing the angle of inclination range AIR during execution of the snow removal routine 2100. For example, if it is desired to dump the snow to the east side of the plurality of photovoltaic modules 190, the angle of inclination range AIR could be temporarily set to a range of AI=−59.9° to −60.0° during execution of the snow removal routine 2100. Similarly, for example, if it is desired to dump the snow to the west side of the plurality of photovoltaic modules 190, the angle of inclination range AIR could be temporarily set to a range of AI=+59.9° to +60.0° during execution of the snow removal routine 2100.

It should be understood that the snow removal routine 2100 of the present disclosure would generally be simultaneously applied to all of the plurality of solar tracker assemblies 100 of the solar tracker installation 1000 when the snow removal decision is made. The logic being that all of the upper surfaces 199 of the plurality of photovoltaic modules 190 of each of the plurality of solar tracker assemblies 100 of the solar tracker installation 1000 being on a single geographic site 1002 would likely experience approximately the same snow accumulation on upper surfaces 199 of their respective photovoltaic modules 190 and, thus, all of the solar tracker assemblies 100 would need snow removal at the same time. This would be true, for example, if all of the photovoltaic modules 190 of all of the solar tracker assemblies 100 were configured in the same manner (one-in-portrait configuration), had similar sized and similar strength photovoltaic modules and similar table support structures for the modules, etc. However, it should be understood that if, for example, the photovoltaic modules 190 of solar tracker assemblies 100 have different configurations (one-in-portrait vs. two-in-landscape) or differing sized or differing strength photovoltaic modules and/or support structures, if may be desirable to identify common sets of solar tracker assemblies of the installation 1000 and apply the method of snow removal 2000 separately to each of the differing sets of solar tracker assemblies. For example, if the method of snow removal 2000 was applied to the set of solar tracker assemblies of the installation 1000 whose photovoltaic modules are configured in one-in-portrait configuration, when the snow removal decision is made (i.e., it was determined that the snow removal routine 2100 should be executed), it would be executed for the set of solar tracker assemblies of the installation 1000 whose photovoltaic modules are configured in one-in-portrait configuration. The method of snow removal 2000 would be separately applied to the set of solar tracker assemblies whose photovoltaic modules are configured in two-in-landscape configuration. For example, in the simplified depiction of FIG. 1, solar tracker assemblies 102, 103, 104, 106, 107 would constitute a set of solar tracker assemblies having a one-in-portrait configuration, while solar tracker assembly 108 would constitute a set of solar tracker assemblies having a two-in-landscape configuration. Thus, execution of the snow removal routine 2100 may be different for the set of one-in-portrait solar tracker assemblies vs. the set of two-in-landscape solar tracker assemblies of the installation 1000. Of course, it should be appreciated that other means of determining what constitutes a set of solar tracker assemblies of the plurality of solar tracker assemblies 100 may be used. For example, a set of solar tracker assemblies may constitute a geographic grouping of solar tracker assemblies in a certain area or region of the installation site 1002, e.g., a set of solar tracker assemblies in an eastern region 100a of the installation site 1002.

The method of snow removal 2000, in one example embodiment, is implemented as one or more computer programs/software routines, executed by a computer processor associated with the solar tracker installation 1000. In one example embodiment, the processor that executes the programming steps and routines of the method of snow removal 2000 is the array controller 510, which is part of a wireless solar tracker control and communications system 500 of the solar tracker installation 1000. The plurality of solar tracker controllers 600 are also part of the solar tracker control and communications system 500. While, in one example, embodiment, the array controller 510 is the processor that executes the software of the method of snow removal 2000, it should be recognized that the processor execution snow removal method software/programming may be distributed among other computing/processing resources of the control and communications system 500, for example, the microprocessors which are part of each of the plurality of solar tracker controllers 600, and/or include one or more processors that are remote from the installation 1000.

It should be understood and appreciated that the snow removal method 2000 of the present disclosure may be implemented in a variety of ways. Three snow removal models or processes 2002a, 2002b, 2002c will be presented herein to illustrate various example embodiments of the snow removal method 2000. However, it should be understood and appreciated that other models or processes may be used to implement the snow removal method 2000 and it is the intent of the present disclosure that such other models or processes, as would be understood by one of skill in the art, are within the scope of the present disclosure. In the first model 2002a (if-then decision tree), an if-then decision tree is utilized to determine if the current condition or current condition status 2007, based on a set of input variable values 2005, corresponds to a snow removal condition 2052 and, if so, the snow removal routine 2100 is executed. In a second model 2002b (decision matrix), a decision matrix or chart is utilized to determine if the current condition or current condition status 2007, based on a set of input variable values 2005, corresponds to a snow removal condition 2052 and, if so, the snow removal routine 2100 is executed. In the third model 2002c (binary status word comparison), a current condition status word 2008, based on a set of input variable values 2005, is compared to a set of snow condition status words 2054 and, if so, the snow removal routine 2100 is executed. Similarly, the snow removal method 2000 of the present disclosure contemplates the use of machine learning/artificial intelligence (ML/AI) concepts/processes to improve the efficacy and effectiveness of the snow removal method 2000 utilizing historical data tracking the success/failure of previous executions of the snow removal routine 2100 and statistical analysis of such data. Specifically, the snow removal method 2000 utilizes a machine learning process and/or artificial intelligence concepts 2200 to improve the snow removal process by examining and changing/modifying over time: a) the choice of input variables 2005 selected for inclusion in the snow removal models 2002a, 2002b, 2002c; b) the criterion for determining what variable and variable values should be used to define a snow removal condition 2052 and, with respect to model 2002c, the criterion for determining what variable and variable values should be used to define the set of snow condition status words 2054; and c) what the decision rule or rules 2050 should be used to determine if execution of the snow removal routine 2100 is appropriate. While one machine learning process 2200 is presented herein for illustration purposes, it should be understood and appreciated that many modifications and versions of ML/AI concepts could be applied to improve the effectiveness/efficacy of the snow removal process 2000 and it is the intent of the present disclosure that such modifications and versions of ML/AI concepts, as would be understood by one of skill in the art, are within the scope of the present disclosure.

To implement the method of snow removal 2000 of the present disclosure, the installation 1000 will, in one example embodiment, include the following: a) the plurality of weather sensors 700 periodically providing input data or variable values 2005 to the array controller 510; b) the plurality of solar tracker controllers 600 for executing or implementing a snow removal function or routine 2100, at such time the snow removal routine 2100 is determined to be appropriate; and c) the central processor/controller or array controller 510 applying decision logic decision rule 2050 to determine if the snow removal routine 2100 should be executed. The decision logic 2050, embodied in software or programming implemented by, in one example embodiment, the array controller 510, receives current values 2005 corresponding to a selected set of input variables 2005, which may include one or more values from the following categories: snow presence variable category 2010, weather condition variable category 2020 (from the plurality of weather sensors 700), temporal variable category 2030, and snow removal routine variable category 2040. The array controller 510 will perform an input variable transformation function 2006 to convert the current values of the selected set of input variables 2005 into a current condition status 2007 of the installation 1000. The transformation function 2006 is a mapping or transformation of current input variable values 2005 into a format that can be used by the decision rule 2050 to make a comparison between the current snow condition status 2007 and a snow removal condition 2052 to determine if execution of the snow removal routine 2100 is appropriate.

In one example embodiment, namely the snow removal model 2002c, the current condition status 2007 is represented by a current condition status word or string 2008 and the snow removal condition 2052 is represented by a set of snow condition status words 2054. That is, the set of snow condition status words 2054 are indicative of and correspond to the snow removal condition 2052. The decision rule 2050 compares the current condition status word 2008 to the set of snow condition status words 2054. If there is a match between the current condition status word 2008 and a snow condition status word of the set of snow condition status words 2054, then the decision is to execute the snow removal routine 2100. The array controller 510 sends appropriate control signals to the plurality of solar tracker controllers 600 of the installation 1000 to execute the snow removal routine 2100. After execution of the snow removal routine 2100, an updated value of an output variable, namely, a snow removal routine success variable or snow removal routine result variable 2044 is determined so that the success of the snow removal routine 2100 in removing accumulated snow from the upper surfaces 199 of the photovoltaic modules 190 may be documented for use by a machine learning process 2200 of the snow removal method 2000 of the present disclosure.

The array controller 510 executes the decision rule or decision logic 2050 compares the current condition status 2007 to the snow removal condition 2052 to determine if the snow removal routine 2100 should be executed. More specifically, in one example embodiment, the decision rule 2050 compares the current condition status word 2000 to the set of snow condition status words 2054 to determine if the snow removal routine 2100 should be executed. The decision rule 2050 may include algorithms, heuristics, logic/decision trees, data tables, flow charts/diagrams, data manipulations and comparisons, and/or application of artificial intelligence/machine learning methods, etc., implemented on software, hardware, and/or firmware, to determine if, based on the current condition status 2007, the snow removal routine 2100 should be executed, and, if so, sending appropriate control signals to the solar tracker controllers 600 to execute the snow removal routine 2100. As an example of the transformation function 2006, if the current irradiance input variable value is 75 mW/cm² and the snow condition status word 2054 classifies irradiance as a Boolean variable as follows: “If the irradiance value is greater than or equal to 90 mW/cm², then irradiance value=1, otherwise irradiance value=0”, in order to allow the decision rule 2050 to make a comparison between the current condition status word 2008 and the set of snow condition status words 2054, the transformation function 2006 would convert or map the current irradiance input variable value of 75 mW/cm² into an irradiance Boolean value of 0 for inclusion in the current condition status word 2008.

The method of snow removal 2000 includes the following steps: a) periodically provide an updated set of input variable values 2005; b) applying the input variable transformation function 2006 to generate a current condition status 2006a; c) applying the decision rule 2050 determine if the current condition status 2007 corresponds to a snow removal condition 2052, and; d) if so, to execute the snow removal routine 2100. In one example embodiment, the current condition status 2007 is a current condition status word or string 2007. The decision rule 2050 compares the current condition status word 2007 to a set of snow condition status words 2054 to determine if a snow removal condition 2052 exists. That is, if the current condition status word 2007 matches a status work in the set of snow condition status words 2054, then a snow removal condition 2052 is deemed to exist and the snow removal function 2100 is executed for the solar tracker assemblies 100 of the solar tracker installation 1000. In one example embodiment, namely snow removal model 2002c, the decision rule 2050 involves referencing a look-up table having a set of snow condition status words 2054. However, it should be appreciated that other decision paradigms, e.g., snow removal models 2002a, 2002b, may be utilized by the decision rule 2050 to determine if the current condition status 2007 corresponds to a snow removal condition 2052.

The current input variable values 2005 that are utilized by the input variable transformation function 2006 are current values of variables from the following categories of variables: a) snow presence variables 2010; b) weather condition variables 2020; c) temporal variables 2030; d) weather prediction variables 2035; and e) snow removal routine variables 2040. The snow removal routine variables 2040 include one input variable and one output variable. The snow presence variable category 2010 includes the following: 1) a snow magnitude variable subcategory 2012, which includes two variables: i) snow depth variable 2013 (what is the depth of the accumulated snow on the upper surfaces 199 of the plurality of photovoltaic modules 190); ii) snow weight variable 2014 (what is the weight of the accumulated snow on the upper surfaces 199). The snow presence variable category 2010 also includes a snow reflectance variable 2016 (what is the reflectance magnitude of the accumulated snow on the upper surfaces 199 of the photovoltaic modules 190).

The weather condition variable category 2020 includes the following variables: 1) ambient temperature variable 2022; 2) temperature gradient variable 2024 (what is the change in temperature over a predetermined time interval); 3) irradiance variable 2026 (sunlight vs. overcast condition); 4) snowing condition variable 2028 (is it currently snowing); and 5) photovoltaic module temperature variable 2029. The temporal variable category 2030 includes the following: 1) time of day variable 2032; and 2) daytime/nighttime variable 2034. The weather prediction variable category 2035 includes the following variables: 1) snowfall prediction variable 2036 (If it is currently snowing, when is snowfall predicted to end? If it is not snowing now, when is snowfall predicted to commence?); 2) ambient temperature change prediction variable 2037 (Is ambient temperature expected to rise or fall over the next predetermined time interval?). An example of utilizing the weather prediction variable category 2035 would be as follows. If the snowfall prediction variable value 2036 indicates that it will stop snowing soon, the decision rule 2050 may consider this variable value 2036 as part of the generated snow condition status 2007 and in determining whether or not there is a snow removal condition 2052. The decision rule 2050 may, for example, delay execution of the snow removal routine 2100 in view of the prediction of it will stop snowing soon, that is, wait until the predicted time of snow ending before executing the snow removal routine 2100. Another example of utilizing the weather prediction variable category 2035 would be as follows. If the ambient temperature change prediction variable 2037 indicates that ambient temperature will rise to above freezing temperature, the decision rule 2050 may utilize this variable value 2037 as part of the generated snow condition status 2007 and in determining whether or not there is a snow removal condition 2052. The decision rule 2050 may, for example, delay execution of the snow removal routine 2100 in view of the prediction of rising temperature above freezing, that is, wait until the predicted time when ambient temperature is above freezing before executing the snow removal routine 2100 so that the snow will more easily slide off the upper surfaces 199 of the plurality of photovoltaic panels 190. Real time weather prediction data for areas in proximity to or including the installation site 1002 may be available via internet weather prediction sites.

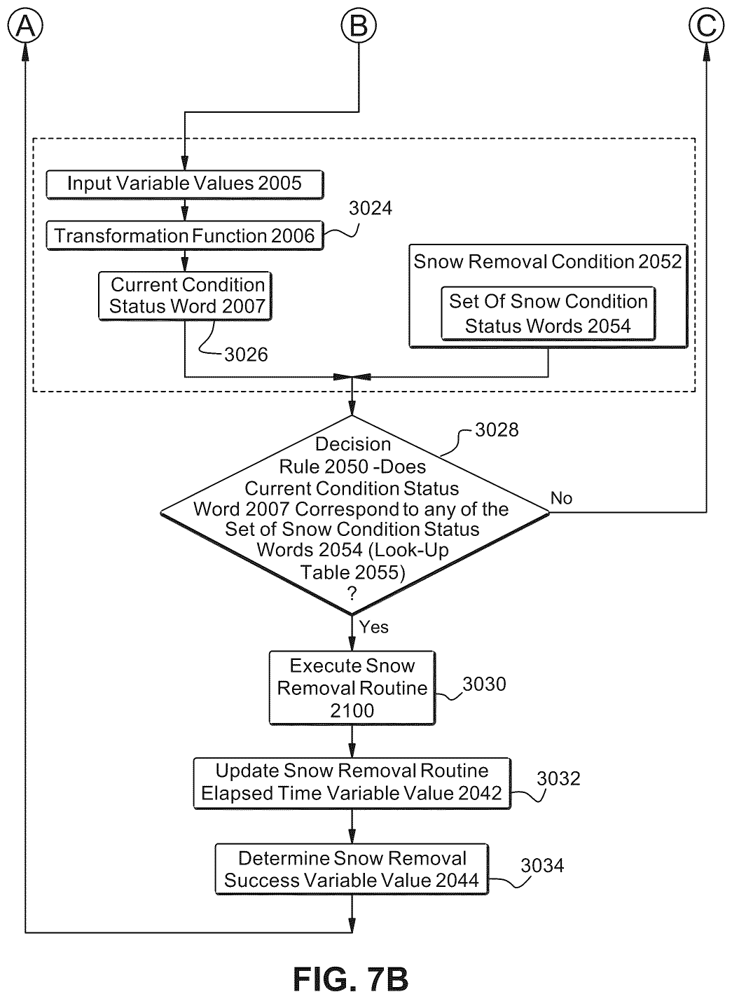

As noted above, the snow removal routine variable category 2040 include one input variable and one output variables as follows: 1) input variable—a snow removal routine elapsed time variable (duration of time from last execution of snow removal routine 2100); and 2) output variable—snow removal routine success variable (assuming that the snow removal routine 2100 is executed, how successful was the routine in clearing accumulated snow from the upper surfaces 199 of the plurality of photovoltaic modules 190). The snow removal success variable 2100 is used by the method of snow removal 2000 as part of a machine learning process 2300 (FIG. 8) wherein the method 2000 uses historical data and statistical analysis to continuously improve the correlation between the input variables selected for inclusion in a snow removal model 2002 and the snow removal routine success variable 2044.

In one exemplary embodiment, the plurality of weather sensors 700 include both table-mounted weather sensors 700b, which are mounted to and pivot with the table 110 through the angle of inclination, and post-mounted weather sensors 700a, which are fixed and distributed about different regions of the installation site 1002. Generally, measurement of snow presence variable values 2010 are provided by table-mounted weather sensors 700b, while weather condition variable values 2020 are provided by post-mounted weather sensors 700a. One weather condition variable 2020, namely, In one example embodiment, the weather sensor 702 is a table-mounted, snow weight sensor, for example, a load cell/force transducer mounted in the plane of the photovoltaic modules 190 of the solar tracker assembly 102 such that the upper surface of the sensor 702 is mounted in the same plane as the upper surfaces 199 of the photovoltaic modules 190. The snow weight weather sensor 702 provides measurements as to the weight of snow accumulating on the panel. Thus, the snow weight weather sensor 702 provides a variable value for snow weight of accumulated snow 2014 on the upper surfaces 199 of the photovoltaic modules 190. Advantageously, the snow weight weather sensor 702 also provides a means for determining the snow removal routine success variable 2044. That is, the upper surface of the snow weight sensor 702 is similar in frictional properties to the photovoltaic module upper surfaces 199. Thus, when the snow removal routine 2100 is executed, accumulated snow slides off of the upper surface of the snow weight weather sensor 702 to the same extent that accumulated snow slides off the upper surfaces 199 of the plurality of photovoltaic modules 190 of the solar tracker assembly 102.

Another table-mounted weather sensor 704 is an ultrasonic sensor that is mounted on the table 110 above the upper surface 199 of a photovoltaic module 190. The ultrasonic weather sensor 704 provides values for the snow depth variable 2013, that is, the depth of accumulated snow on the upper surface 199 of the photovoltaic modules 190 of the solar tracker assembly 102. In one example embodiment, the ultrasonic sensor 704 is calibrated to a zero snow depth level (no snow on the upper surfaces 199 of the modules 190) and utilizes the reflection of ultrasonic waves to detect a reduction in the distance between the ultrasonic sensor 704 and the module upper surface 199. The reduction magnitude can be inferred as the accumulated snow depth on the upper surface 199. A more complex ultrasonic sensor weather sensor 704 may additionally sense whether it is currently snowing to provide value for the snowing condition variable 2028 of the weather condition variable category 2020.

However, it should be appreciated that the snowing condition variable 2028, which is a Boolean variable—SF=0—currently not snowing at the installation site 1002 and SF=1—currently snowing at the installation site 1002, is more likely to be measured indirectly. For example, to determine a value for the snowing condition 2028 take periodic, successive measurements of one or more variables in the snow presence variable category 2010 and if the snow presence variable values have not changed over the successive measurements, then it may be inferred that it is not snowing at or in the area or vicinity of the installation site 1002 over a time period corresponding to the successive measurements of the snow presence variable values and thus the snowing condition variable 2028 may be set to SF=0—not snowing at the installation site 1002. For example, if three consecutive measurement values taken over a period of, say, 15-30 minutes, of the snow depth variable 2013 indicate no increase or no change in snow depth, then it may be inferred that there is no snowfall currently at the installation site 1002 and the snowing condition variable 2028 may be set to SF=0 (not snowing at the installation site 1002). As other example, if three consecutive measurement values of the snow weight variable 2014 indicate no increase or no change in snow weight, then it may be inferred that there is no snowfall currently at or in the area or vicinity of the installation site 1002 and the snowing condition variable 2028 may be set to SF=0 (not snowing at the installation site 1002). It should be appreciated, of course, that rule used to determine the number of consecutive “no change” or “no increase” measured values that must be obtained to conclude that SF=0 for the snowing condition variable 2028 at the installation site 2028 as well at the total time period over which the consecutive measured values are obtained may be varied based on accumulated experience and knowledge, as would be understood by one of skill in the art. Further, as used herein, snowing or not snowing “at” the installation site 1002 is understood to mean snowing or not snowing on the grounds of or in the immediate vicinity or area of the installation site 1002.

In one example embodiment, another table-mounted weather sensor 706 is an optical sensor such as a photodiode. The optical sensor weather sensor 706 may be mounted above the photovoltaic modules 190 and thereby measure reflectance values directly. Alternatively, the optical weather sensor 706 may be mounted below a lower surface 199a of the photovoltaic modules 190 and measure transmission of light passing through the photovoltaic modules 190. The optical sensor 706 provides values for the snow reflectance variable 2016. Yet another option is a hybrid weather sensor, which measures two or more snow presence and/or weather condition variables at the same time, e.g., a sensor which makes both optical and ultrasonic measurements with the same sensor. An additional table-mounted weather sensor 708 is photovoltaic module temperature weather sensor 708 which is mounted in proximity to a lower surface 199a of a photovoltaic module 190 and, thus, provides values for the module temperature variable 2029. The table-mounted temperature weather sensor 708 measures temperature at the lower surface or back side 199a of a photovoltaic module 190 providing an indication as to how hot the photovoltaic module 190 is. If the module temperature is above 0 degrees C., snow in contact with the upper surface 199 of the module 190 may melt, allowing snow to slide more easily off the upper surface 199 when the snow removal routine 2100 is executed.

Post-mounted weather sensors 700a such as weather sensors 708 (ambient temperature sensor), 710 (irradiance sensor), 712, 714 will generally be used for measuring the weather condition variable values 2020 including: the ambient temperature variable 2022, the irradiance variable 2016, and the snow presence in the air variable 2018. Additionally, with an elapsed time calculation, values can be computed for the temperature gradient or temperature trend variable 2024. The temperature gradient variable 2024 provides a measure of to what extent is the ambient temperature rising or falling over the most recent 15 minute interval of time. Generally, ambient temperature measurement sensors would be mounted on support posts 140 as there is no need for an ambient temperature sensor to pivot with a solar tracker assembly table 110. The post-mounted irradiance sensor 710 provides values for flux of radiant energy per unit area, that is, a measure of how brightly the sun is shining at the installation site 1002, and thus provides values for the irradiance variable 2026. The irradiance sensor 710 may also provide an indirect measure of the snowing condition variable 2028, i.e., the irradiance sensor 710, via measuring irradiance can provide a Boolean value (0/1—no/yes) for the snowing condition variable 2028, that is-currently snowing at installation site—no/yes—0/1?

It should be understood, the set of snow presence values 2010 may be measured by a single weather condition sensor 700 (e.g., snow reflectance variable values 2016 output by the optical sensor 706) or multiple weather condition sensors 700 (e.g., snow reflectance variable values 2016 output by the optical sensor 706, snow weight variable values 2014 output by a weight sensor 702, snow depth variable values 2013 output by the ultrasonic sensor 704, etc.). The values may be a single value or a set of consecutive values taken over time, which may then be manipulated and/or filtered to determine, for example, an average value or a weighted average value or a value with outliers discarded. Similarly, the set of weather condition values 2020 may be measured by a single weather condition sensor 700 (e.g., snow-in-the-air variable values output by the ultrasonic sensor 704 or the irradiance sensor 710) or multiple weather condition variable values (e.g., snow presence in the air variable values output by the ultrasonic sensor 704, ambient temperature variable values 2022 output by the post-mounted temperature sensor 708, and irradiance variable values 2026 output by the irradiance sensor 710, etc.). The values may be a single value or a set of consecutive values taken over time, which may then be manipulated and/or filtered to determine, for example, an average value or a weighted average value or a value with outliers discarded. For example, an outlier from a weather condition sensor 710 may indicate that the sensor is malfunctioning and its values ignored until maintenance of the sensor is undertaken.

Additionally, it should be appreciated that since the installation site 1002 may be large in geographical extent and the plurality of weather sensors 700 may be widely scattered across the site, it may be advantageous to segregate or group a particular subset of weather sensors to determine, for example, one or more weather condition variable values 2020 for a given set (i.e. a given subset) of solar tracker assemblies of the plurality of solar tracker assemblies 100 of the solar tracker installation 1000. In FIG. 1, two sets or subsets of weather sensor 701a, 701b (an eastern set 701a located in an eastern region of the installation site 1002 and a western set 701b located in a western region of the installation site 1002) of the plurality of weather sensors 700 are schematically depicted in dashed line. Additionally, two sets or subsets of solar tracker assemblies 100a, 100b of the plurality of solar tracker assemblies 100 are schematically depicted in dashed line corresponding to an eastern region of the installation site 1002 (eastern set of solar tracker assemblies 100a being in proximity to the eastern set of weather sensors 701a) and a western region of the installation site 1002 (western set of solar tracker assemblies 100b being in proximity to the western set of weather sensors 701b), respectively.

By way of example and not in any way intending to be limiting, a first weather condition variable value 2020 may be determined from the eastern set of weather sensors 701a of the plurality of weather sensors 700 and that first value (together with the corresponding snow presence variable values 2010 for the eastern set of solar tracker assemblies 100a) will be used by a snow removal model 2000 of the present disclosure to determine if a snow removal condition 2052 exists for the eastern set (or subset) of solar tracker assemblies 100a of the plurality of solar tracker assemblies 100 of the installation 1000. A second weather condition variable value 2020 may be determined from the western set of weather sensors 701b of the plurality of weather sensors 700 and that second value will be used as part of a snow removal model 2002 of the present disclosure to determine if a snow removal condition 2052 exists for the western set (or subset) of solar tracker assemblies 100b of the plurality of solar tracker assemblies 100 of the installation 1000. That is, by grouping a number of weather sensors in geographic proximity or in a given area of the installation site 1002 (for example, the group of weather sensors 701a located in the eastern region or eastern area of the installation site 1002) and using the output values from the group of eastern weather sensors 701a to determine one or more desired weather condition variable value(s) 2020 to be associated with the eastern subset of the solar tracker assemblies 100a of the plurality of solar tracker assemblies 100 of the installation 1000. Similarly, by grouping a number of weather sensors in geographic proximity or in a given area of the installation site 1002 (for example, the group of weather sensors 701b located in the western region or wester area of the installation site 1002) and using the output values from the group of western weather sensors 701b to determine different one or more desired weather condition variable value(s) 2020 to be associated with the western subset of the solar tracker assemblies 100a of the plurality of solar tracker assemblies 100 of the installation 1000a. In this way, for example, depending on weather condition variable values 2020 for the eastern subset of solar tracker assemblies 100a of the plurality of solar tracker assemblies 100 of the solar tracker installation 1000 and the corresponding snow presence variable values 2010 for the western subset of solar tracker assemblies 100b, a snow removal condition 2052 may be found and the snow removal routine 2100 is executed for the eastern subset of solar tracker assemblies 100a, while no snow removal condition is found for the western subset of solar tracker assemblies 100b. Similarly, it should be appreciated that different methodologies may be used to obtain weather condition variable values 2020, as would be appreciated by one of skill in the art. For example, weather condition variable values 2020 may be determined by averaging the output values of the appropriate weather sensors to obtain a desired weather condition variable value. Alternatively, the output values may be filtered by, for example, dropping very high or very low outliers (presuming that the output values are in error, possibly due to weather sensor malfunction), and then average the remaining output values to obtain a desired weather condition variable value.

As used herein, executing the decision logic or decision rule 2050 will refer to any and all of the foregoing tasks and calculations, as performed by the array controller 510 (or another designated processor of the solar tracker installation 1000. In one example embodiment, the programming/software associated with the input variable transformation function 2006 may be part of the decision rule 2050 software. Alternatively, the transformation function 2006 may be a stand-alone routine. As noted above, if it is determined by the decision rule 2050 that execution of the snow removal routine 2100 is appropriate, the array controller 510 will send appropriate control signals to each solar tracker controller (e.g., solar tracker controller 602) of the plurality of solar tracker controllers 600 to execute the snow removal routine 2100, as appropriate for its associated solar tracker assembly (e.g., solar tracker assembly 102) of the plurality of solar tracker assemblies 100. However, it should be appreciated that the array controller 510 may determine, under specific conditions and depending on differing configurations/components of the solar tracker assemblies 100 of the installation 1000, that control signals for execution of the snow removal routine 2100 may be sent to only a subset of the plurality of solar tracker controllers 600 of the installation 1000. By way of example, execution of the snow removal routine 2100 may be different for one set of solar tracker assemblies of the installation 1000 wherein the solar tracker assemblies have their photovoltaic modules 190 configured in so-called one-in-portrait configuration versus another set of solar tracker assemblies of the installation 100 having their photovoltaic modules 190 configured in a so-called two-in-landscape configuration. In the “one-in-portrait” configuration, as schematically depicted by solar tracker assemblies 102, 103, 104, 105, 106, 107 in FIG. 1, each of the photovoltaic modules 190, as viewed in top plan view, are centered over a torque tube beam 250 of the solar tracker assembly. By contrast, in the “two-in-landscape” configuration, as schematically depicted by solar tracker assembly 108 in FIG. 1, the photovoltaic modules 190, as viewed in top plan view, are supported in two spaced-apart rows on opposite sides of the torque tube beam 250.

For simplicity, the snow removal method 2000 and the snow removal routine 2100 will be described herein as being executed with respect to a single representative solar tracker assembly, i.e., solar tracker assembly 102, it should be understood that when the snow removal routine 2100 is executed, it would be executed with respect to at least a set of the plurality of solar tracker assemblies 100 of the solar tracker installation 1000 having the same configuration. In one example embodiment, the snow removal method 2000 may be viewed as the implementation of a snow removal process 2002 utilizing a dynamic snow removal model 2004. The snow removal process 2001 includes utilizing the decision rule 2050 to determine if a set of input variable values 2005 correlates to a snow removal condition 2051 and, if so, executing the snow removal routine 2100. The snow removal process 2002 is repeated at predetermined intervals throughout the day, for example, every 15 minutes. The snow removal model 2004, by contrast, is the repository of a set of input variables and associated snow condition states that are utilized for the snow removal process 2002, that is, providing the data to allow the decision rule 2050 to step through its decision-making logic and/or comparisons. That is, the snow removal model 2004 determines, of all of the input variables 2001 available to the method 2000, which specific input variables will be included in the set of input variables 2005 used for making the snow removal decision by the decision rule 2050. The snow removal model 2004 also includes a mapping of sets of input variable values into the snow removal condition 2052, that is, does a particular set of input variable values 2005 correspond to a snow removal condition 2052.

Advantageously, in one embodiment, the snow removal method 2000 includes the machine learning process 2200 that uses historical data and statistical analysis to update the snow removal model 2004 in terms of the selection of specific input variables will be included in the set of input variables 2005 and in terms of the sets of variable values that correspond to the snow removal condition 2052. The machine learning process, in essence, seeks use historical data regarding the success of prior executions of the snow removal routine 2100 to improve the correlation between the specific input variables selected for inclusion in the set of input variables 2005 used for making the snow removal decision and a high value of the snow removal routine success variable 2044 (i.e., a snow removal routine 2100 that successfully removes accumulated snow from the upper surfaces 199 of the plurality of photovoltaic modules 190 of the solar tracker assembly 102 would score a high value for the snow removal routine success variable 2044). Historical data may indicate certain input variables of the selected set of input variables 2005 used by the snow removal model 2004 are highly correlated with a high snow removal routine success variable value 2044, while other input variables are not as highly correlated with a high snow removal routine success variable value 2044. A goal of the machine learning process 2200 is to provide the snow removal model 2004 with a set of input variables that exhibit the highest correlation with a high value for the snow removal routine success variable 2044. To this end, different combinations of input variables may be “tested” as a selected set of input values 2005 that is mapped into the snow removal condition 2052 for the purpose of building a historical database of what input variables are good predictors of high snow removal routine success variable values 2044. Ultimately, via the machine learning process 2200, the method of snow removal 2000 will select the optimal or near optimal set of input values 2005 such that: a) snow accumulation is successfully removed by the snow removal routine 2100 at an acceptably high percentage; and b) the number of occurrences of the snow removal routine 2100 being executed when no snow removal is necessary is acceptably low.

### Solar Tracker Installation 1000

As is best seen in FIG. 1, the solar tracker assembly 102 and associated solar tracker controller 602 are representative single axis solar tracker assemblies and solar tracker controllers which are part of a solar tracker installation 1000 located on a solar tracker installation site 1002. The solar tracker installation 1000 includes a plurality of solar tracker assemblies 100. Solar tracker assemblies 102, 103, 104, 106, 107, 108 are schematically depicted in FIG. 1, along with their associated solar tracker controllers 602, 603, 604, 606, 607, 608. In one exemplary or example embodiment, each of the plurality of solar tracker assemblies 100 is a horizontal, single axis solar tracker assembly and each solar tracker assembly of the plurality of solar tracker assemblies 100 operates under the control of an associated different one of a plurality of solar tracker controllers 600 for example, representative solar tracker controllers 602, 603, 604, 606, 607, 608 are schematically depicted in FIG. 1. In one exemplary or example embodiment, each of the plurality of solar tracker controllers 600 is located in proximity to or mounted on its associated solar tracker assembly, for example, solar tracker controller 602 is mounted on a rotatable torque tube beam 250 of its associated solar tracker assembly 102. The plurality of solar tracker controllers 600 are part of a solar tracker control and communications system 500, which includes an array controller 510 which is in wireless communication with each of the plurality of solar tracker controllers 600 and in wireless communication with each of a plurality of weather sensors 700 on the installation site 1002. The array controller 510 is also in wireless communication with a cloud storage database 510.

The discussion hereinafter will be directed to the representative solar tracker assembly 102 and its associated DC powered solar tracker controller 602, it being understood that the configuration and function of the remaining solar tracker assemblies of the plurality of solar tracker assemblies 100 and the remaining solar tracker controllers of the plurality of solar tracker controllers 600 are similar to the solar tracker assembly 102 and the solar tracker controller 602. The solar tracker controller 602 controls an in-line drive mechanism 150 of the solar tracker assembly 102 to rotate a table 110 of the solar tracker assembly 100 about a table axis of rotation R. The table 110 of the solar tracker assembly 102 includes a frame 120 supporting a plurality of photovoltaic modules 190 as well as the smaller, dedicated photovoltaic module 690 that charges the rechargeable battery 645 and is part of the solar tracker controller 602 and the battery/temperature control assembly 650. The rotatable torque tube beam 250 of the table 110, in turn, supports the frame 120. A plurality of bearing apparatuses 200, in turn, rotatably support the torque tube beam 250. The torque tube beam 250 is comprised of a plurality of aligned and couple torque tube beam segments. In the drawings, four torque tube beam segments, namely, first, second, third and fourth torque tube beam segments 260, 265, 270, 275 of the torque tube beam 250 are schematically depicted, it being understood that the solar tracker assembly 100 includes additional torque tube beam segments not shown. The plurality of bearing apparatuses 200 are advantageously configured and positioned such that, other than the first and second torque tube beam segments 260, 265 of the torque tube beam 250 adjacent the in-line drive mechanism 150, the table axis of rotation R, is vertically aligned with, that is, would pass through or be acceptably close, for design purposes, to passing through a center of gravity or center of mass of the table 110. As used herein, the direction X is a horizontal direction parallel to the torque tube beam longitudinal axis LA, typically, in the north-south direction, the direction Y is a horizontal direction orthogonal to the torque tube beam longitudinal axis LA, typically in the east-west direction, and the direction V is a vertical direction orthogonal to X and Y directions. The vertical direction V includes the upward direction UP, away from the ground/substrate G, and the downward direction DW, toward the ground/substrate. For simplicity, it is assumed that the ground/substrate is horizontal (orthogonal to the vertical direction V) extending along and in the region of the torque tube beam 250.

The solar tracker assembly 102 of the present disclosure includes the drive mechanism 150 which, operating under the control of the solar tracker controller 602, pivots or rotates the table 110, including the plurality of photovoltaic modules 190, about the axis of rotation R. The table 110 pivots through an angle of inclination AI such that the plurality of photovoltaic modules 190 follow a position of the sun as the sun moves from east to west. As best seen in FIG. 5, the table 110 rotates through a predetermined angular inclination range AIR between a maximum negative angle of inclination AI− wherein the plurality of photovoltaic modules 190 are facing in an easterly direction to receive sunlight at sunrise and a maximum positive angle of inclination AI+ wherein the plurality of photovoltaic modules 190 are facing in a westerly direction to receive sunlight at sunset. At a neutral angle of inclination AIN, the plurality of photovoltaic modules 190 are substantially horizontal, that is, with their upper light receiving surfaces facing directly upward, as would be the case at high noon where the sun is at its apex in the sky.

In one exemplary embodiment, the single axis solar tracker assembly 102 is a single row, horizontal, single axis solar tracker assembly and the drive mechanism 150, controlled by the solar tracker controller 602, comprises a single slew drive or slew gear drive 160 which pivots the table 110 through the predetermined angle of inclination range AIR to track movement of the sun across the sky/horizon. However, one of skill in the art would appreciate that the concepts of the present disclosure are equally applicable to multiple row solar tracker systems, that is, multiple, spaced apart, parallel rows of solar tracking assemblies, as well as solar tracker systems where multiple slew drives are utilized within a single row to pivot the table 110. The table 110 includes all rotating or pivoting components of the solar tracker assembly 100 including: a) the plurality of photovoltaic modules 190, b) the frame 120 including the plurality of mounting brackets 130 which support the plurality of photovoltaic modules 190 and couple the plurality of photovoltaic modules 190 to the torque tube beam 250, c) the torque tube beam 250, extending generally in a north-south direction and extending horizontally, that is, parallel to the ground G, supports the frame 120 and, in turn, is driven through the angle of inclination range AIR by a rotating drive or rotatable drive member 170 of the drive mechanism 150; d) the rotatable bearing assemblies 210 of each of the plurality of bearing apparatuses 200 positioned at spaced apart intervals along the torque tube beam 250 which rotatably support the torque tube beam 120 (and thereby the frame 120 and plurality of photovoltaic modules 190) and define the axis of rotation R of the table 110; and e) the rotating drive 170 of the slew drive 160.

Each bearing apparatus, for example first and second bearing apparatuses 202, 204 of the plurality of bearing apparatuses 200 includes the rotatable or rotating bearing assembly 210, the stationary saddle assembly 220 and a connecting assembly 230. The torque tube beam 250 extends through and is supported by the rotatable bearing assembly 210 which rotates the torque tube beam 250 about the table axis of rotation R. The rotatable bearing assembly 210 of the bearing apparatus 200, in turn, is supported by the stationary saddle assembly 220. The stationary saddle assembly 220 constrains the pivoting or rotation of the rotatable bearing assembly 210 such that the bearing assembly and the torque tube section extending through and supported by the rotatable bearing assembly 210 rotate about a bearing axis of rotation. The table axis of rotation R (except in the region of the slew drive 160) is collectively defined by axes of rotation of the plurality of bearing apparatuses 200 positioned at spaced apart internals along the extent of the torque tube beam 250. Stated another way, each bearing axis of rotation of each bearing apparatus defines a portion of the overall table axis of rotation R. The individual axis of rotation of each of the plurality of solar tracker bearing apparatuses 200 are substantially aligned to or coincident to form a single or combined table axis of rotation R. The exception to this is the region or segments of the torque tube beam 250 adjacent the slew drive 160 and the first and second concentric drive journals 310, 350. In this region, the axis of rotation R of the table 110 is defined by the drive mechanism axis of rotation SDR, that is, the axis of rotation of the rotating drive or rotating drive member 170 of the slew drive 160.

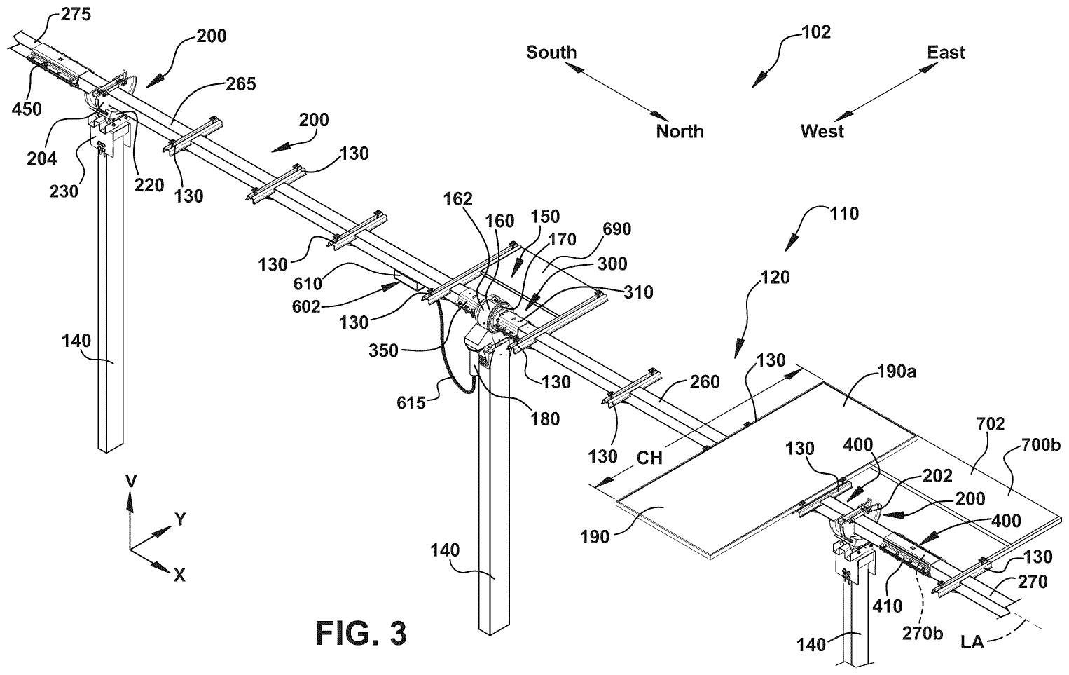

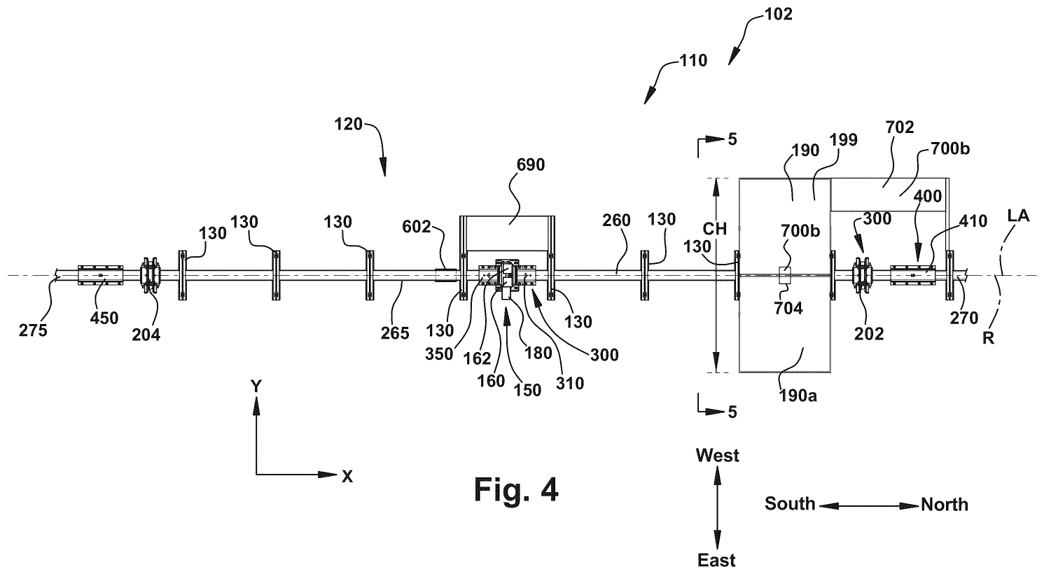

The stationary saddle assembly 220 is mounted by the connecting assembly 230 to a support post 140, which is driven into the ground/substrate G or otherwise secured in the ground/substrate G by, for example, concrete. Thus, the support post 140 and connecting assembly 230 determine the position and the vertical height HT of the rotatable bearing assembly 200. Each of the support posts 140 extend in the vertical direction V along a vertical center line or central vertical axis PCVA (FIG. 5) of the support post 140. For each of the support posts 140, a vertical center line VCL of the bearing assembly 200 is aligned with the center line of the support post 140. The slew drive 160 is similar affixed to a support post 140, which determines the position and vertical height of the rotating drive 170 of the slew drive 160 for purposes of the concentric drive configuration 500. The frame 120, in one exemplary embodiment, includes a plurality of mounting brackets 130 which are spaced along the longitudinal extent of the torque tube beam 250 and each of which is affixed to the torque tube beam 250. Each of the plurality of mounting brackets 130 function to individually secure each photovoltaic module, such as the representative photovoltaic module 190a, of the plurality of photovoltaic modules 190 to the torque tube beam 250. For simplicity, only the single representative photovoltaic module 190a is schematically depicted in FIGS. 3 and 4. Also not shown in the drawings are a number of clamps and fasteners, which are part of the frame 120 and facilitate securing the plurality of photovoltaic modules 190 to the plurality of mounting brackets 130 and securing the plurality of mounting brackets 130 to the torque tube beam 250. Additional details concerning the configuration of the bearing apparatuses and the frame/mounting brackets may be found in U.S. Pat. No. 10,944,354 to Ballentine et al. and U.S. Pat. No. 11,271,518 to Ballentine et al., both of which are assigned to the assignee of the present application and both of which are incorporated herein by reference in their respective entireties.

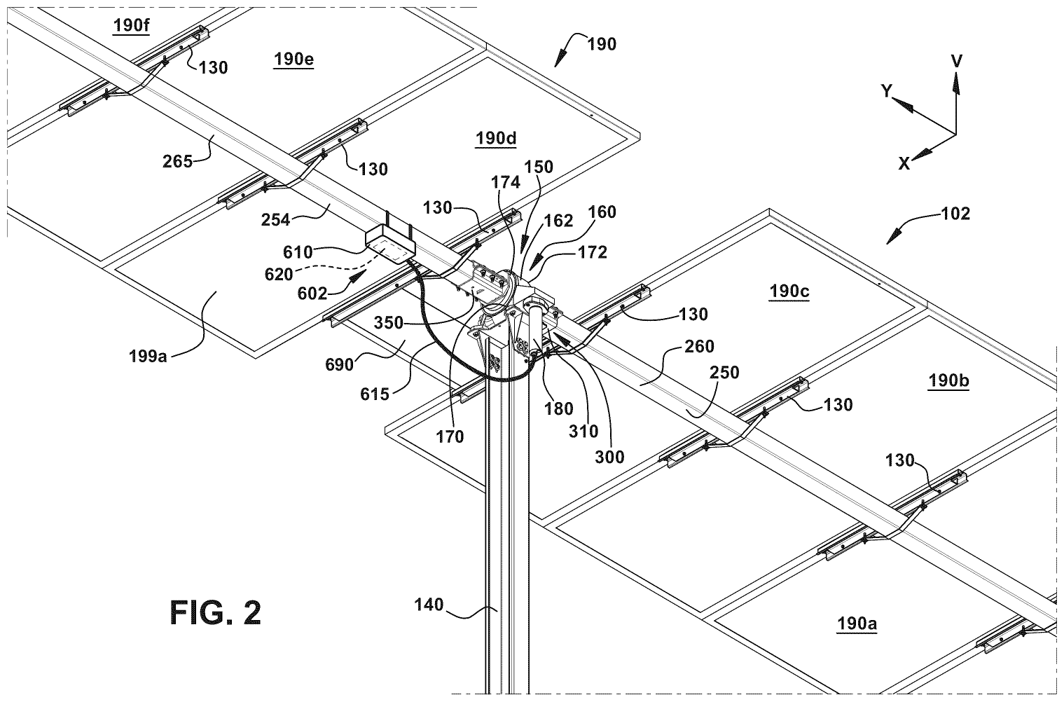

In one exemplary embodiment, the torque tube beam 250 comprises a hollow metal tube that is substantially square in cross section, having an open interior that is centered about a central longitudinal axis LA. In one exemplary embodiment, the torque tube beam 250 is approximately 100 mm. by 100 mm. (approximately 4 in. by 4 in.) and includes an upper wall 252 and a lower wall 254 spaced apart by parallel side walls 258. The torque tube beam 250 extends along the longitudinal axis LA of the torque tube beam 250 and, as noted above, extends generally parallel to the ground G. Hence, as the ground is generally horizontal, the solar tracker assembly is referred to as a horizontal, single axis solar tracker assembly 100. The torque tube beam 250 is comprised of a number of connected torque tube beam segments, each of which is approximately 40 feet in length. In the schematic depiction of FIGS. 1, 2, 4 and 5, only a portion of the solar tracker assembly 100 and, thus, only a portion of the extent of the torque tube beam 250 and the frame 120 and a portion of the total number of bearing apparatuses of the plurality of bearing apparatuses 200 are shown. For example, in FIGS. 2, 3 and 4, the first and second torque tube beam segments 260, 265 and portions of the third and fourth torque tube beam segments 270, 275 are schematically depicted. Of course, it should be appreciated that given that a torque tube beam segment is typically 40 feet in length and a typical photovoltaic module, such as the representative photovoltaic module 190a is approximately 1 meter by 2 meters and is mounted to the torque tube beam 250 in portrait orientation, many more photovoltaic modules would be present on any given torque tube beam segment than is schematically depicted in the FIGS. 1 and 2. Given that the plurality of photovoltaic modules 190 are supported in one-in-portrait orientation by the plurality of mounting brackets 130, a width or chord CH of the table 110 is typically 2 meters.

As previously noted, depending on the table configuration, the plurality of photovoltaic modules 190 may be in landscape or portrait orientation with respect to the torque tube beam 250. For example, in the “one-in-portrait” photovoltaic module mounting configuration for the solar tracker assembly 102, a single row of photovoltaic modules overlies the torque tube beam 250 and extend outwardly in an east-west direction from the torque tube beam 250. If each of the photovoltaic modules of the plurality of photovoltaic modules 190 of the solar tracker assembly 102 includes a 2 meter long by one meter wide photovoltaic module which is mounted to the torque tube beam 250 by the frame 120, then approximately one meter of each photovoltaic module will extend outwardly on either side of a center of the torque tube beam 250, as the solar tracker assembly 102 is viewed in top plan view. To achieve a proper balance, the photovoltaic modules of the solar tracker assembly are positioned such that that a total weight of the frame 120, including the plurality of photovoltaic modules 190 and associated mounting components of the frame 120 (e.g., module rails, clamps, brackets and fasteners), are approximately equally distributed on either side of the torque tube beam 250, as viewed in top plan view. As viewed in top plan view, an extent of each photovoltaic module, as measured in an east-west direction, when the module 190a is horizontal, is referred to as a “chord” or “chord value”, while a distance between adjacent solar tracker assemblies, for example, adjacent solar tracker assemblies 102, 103, as measured between center lines of the torque tube beam 250, is referred to as a “pitch” or “pitch distance” P (FIG. 1). The ratio of chord to pitch is typically about 3:1 for a so-called “one-in-portrait” photovoltaic module mounting configuration. For example, if the photovoltaic modules each have a dimension of 2 meters by 1 meter, in a “one-in-portrait” photovoltaic module mounting configuration, each module is mounted to the torque tube beam 250 such that the 2 meter length of the photovoltaic module extends in the east-west direction and the 1 meter length extends along the torque tube beam in the north-south direction. In such a “one-in-portrait” configuration, the chord value CH is 2 meters, while the pitch distance P will be on the order of 6 meters. Accordingly, a distance D between facing edges 191, 192 of the photovoltaic modules 190 of solar tracker assemblies 102, 103 would be 4 meters. Of course, it should be appreciated that given that a torque tube beam segment is typically 40 feet in length many more photovoltaic modules would be present on any given torque tube beam segment than is schematically depicted in FIGS. 1-4.

The solar tracker assembly 100, in one exemplary embodiment may include five, 40-foot torque tube beam segments on one side of the drive mechanism 150 and another five, 40-foot torque tube beam segments on an opposite side of the drive mechanism 150 providing a total north-south extent or length of the torque tube beam 250 of approximately 400 feet. End portions of adjacent torque tube beam segments, such as, for example, first and third torque tube beam segments 260, 270, are affixed together by a first coupler 410 of a plurality of couplers or splicing members 400 and the second and fourth torque tube beam segments 265, 275 are affixed together by a second coupler 450 of the plurality of couplers 400. A first end portion of the first torque tube beam segment 260, is received by and affixed to the first concentric drive journal 310. Similarly, a first end portion of the second torque tube beam segment 265 is received by and affixed to the second drive journal 350.

The representative solar tracker assembly 102 includes the drive mechanism 150 which, in one exemplary embodiment, includes the slew drive 160 having the stationary housing 162 supporting the rotating drive member 170. The drive mechanism 150 of the solar tracker assembly 102 operates under the control of the solar tracker controller 602 to pivot or rotate the table 110, including the plurality of photovoltaic modules 190, about the table axis of rotation R. Disposed within the stationary housing 162 is a gear train of the slew drive 160 which is operatively coupled to and drives the rotating drive member 170 about a drive mechanism axis of rotation. The drive mechanism 150 further includes a DC motor 180 coupled to the stationary housing 162 of the slew drive 160. In one exemplary embodiment, the DC motor 180 is a brushed 24 volt DC motor. An output shaft of the DC motor 180 is operatively connected to a gear train of the slew drive 160 such that rotation of the output shaft of the DC motor 180 rotates the slew drive gear train. The slew drive gear train, in turn, is operatively coupled to the rotating drive member 170 of the slew drive 160 such that actuation of the DC motor 180 and rotation of the DC motor output shaft causes a proportional and precise rotation of the rotating drive member 170 of the slew drive 160. This rotation of the slew drive rotating drive member 170, in turn, precisely rotates the table 110 of the solar tracker assembly 102 to a desired table angle of inclination AI. That is, rotation of the rotating drive member 170 of the slew drive 160 by the DC motor 180 causes a precise rotation of the table 110 of the solar tracker assembly 102 to a desired table angle of inclination AI (within, of course, the limits of the table angle of inclination range AIR). Additional details regarding the structure and function of a horizontal, single axis solar tracker assembly are disclosed in U.S. Pat. No. 10,944,354 to Ballentine et al., issued Mar. 9, 2021 (“the '354 patent”), and U.S. Pat. No. 11,271,518 to Ballentine et al., issued Mar. 8, 2022 (“the '518 patent”), both of which are assigned to the assignee of the present application. Both the '354 patent and the '518 patent are incorporated by reference herein in their respective entireties.

### Method of Snow Removal 2000

As explained previously, snow accumulation on upper or sun facing surfaces 199 of one or more of the plurality of photovoltaic modules 190 of the solar tracker assembly 102 can adversely impact energy production of the solar tracker assembly 102. Further, since the plurality of solar tracker assemblies 100 of the solar tracker installation 1000 are in close geographic proximity on the installation site 1002, snow accumulation on the upper surfaces 199 of the plurality of photovoltaic modules 190 of one solar tracker assembly 102 likely means that similar snow accumulation would be present on the upper surfaces 199 of the plurality of photovoltaic modules 190 of the other solar tracker assemblies of the plurality of solar tracker assemblies 100. Thus, if the snow removal method 2000 determines that weather conditions indicate that the snow removal function or routine 2100 should be initiated. In one example embodiment, the snow removal routine 2100 is applied to all of the solar tracker assemblies of the plurality of solar tracker assemblies 100 of the solar tracker installation 1000, even though it should be recognized that the angle of inclination path executed by the routine 2100 may be different for solar tracker assemblies of the installation 1000 that are configured, for example, in one-in-portrait configuration versus solar tracker assemblies of the installation 1000 that are configured in two-in-landscape configuration, as previously discussed. In another example embodiment, given the geographic extent of the installation site 1002, the snow removal routine 2100 may only be applied, as mentioned above, to a subset of the solar tracker assemblies of the plurality of solar tracker assemblies 100 of the solar tracker installation 1000.

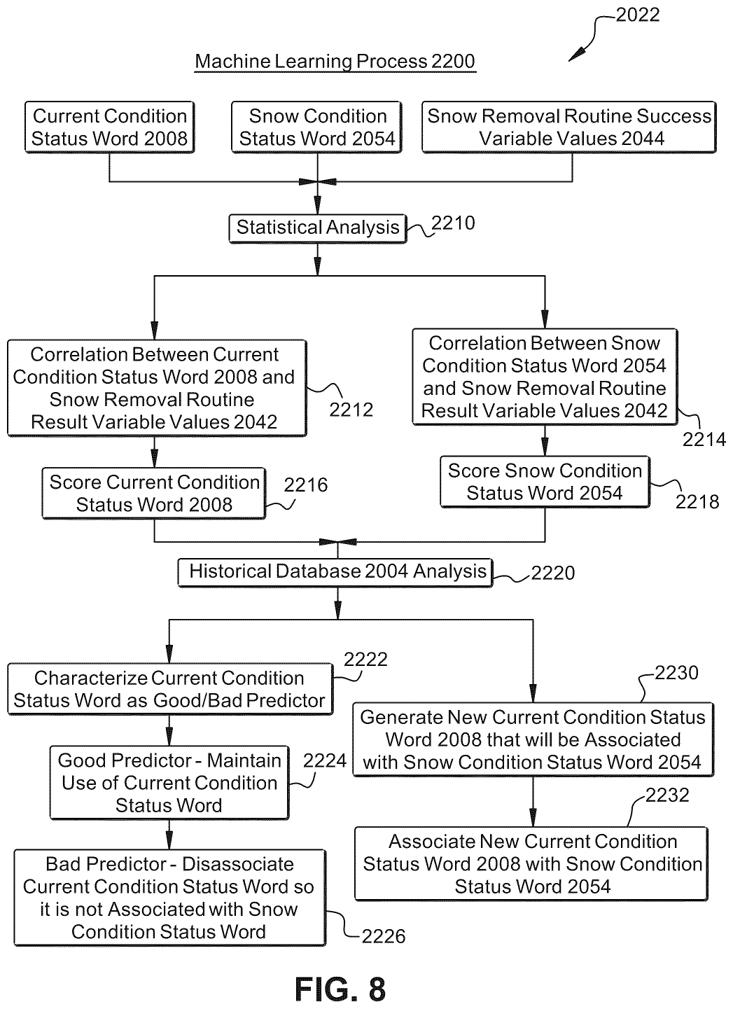

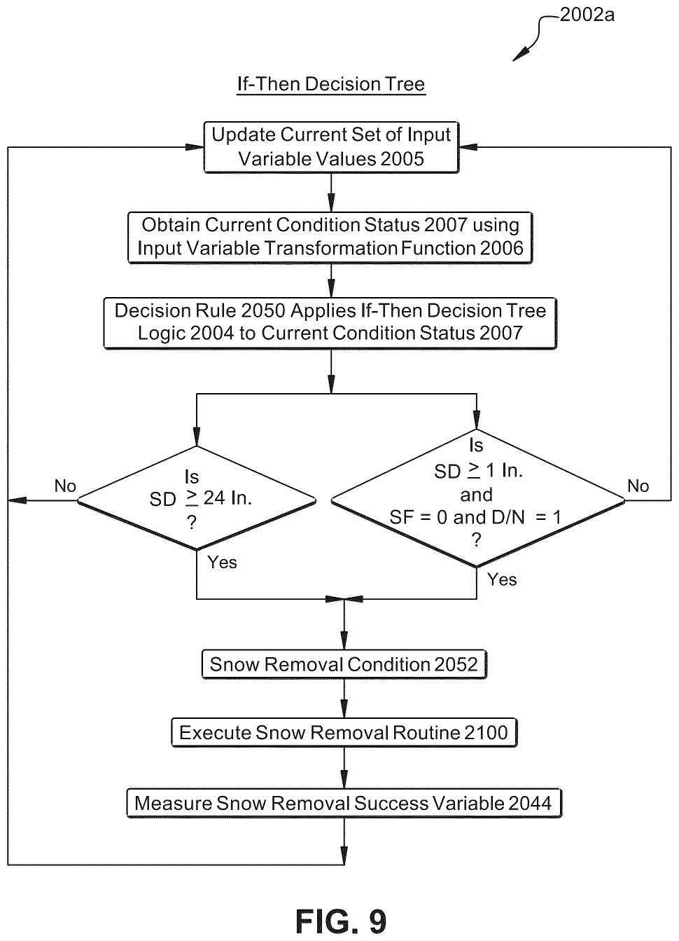

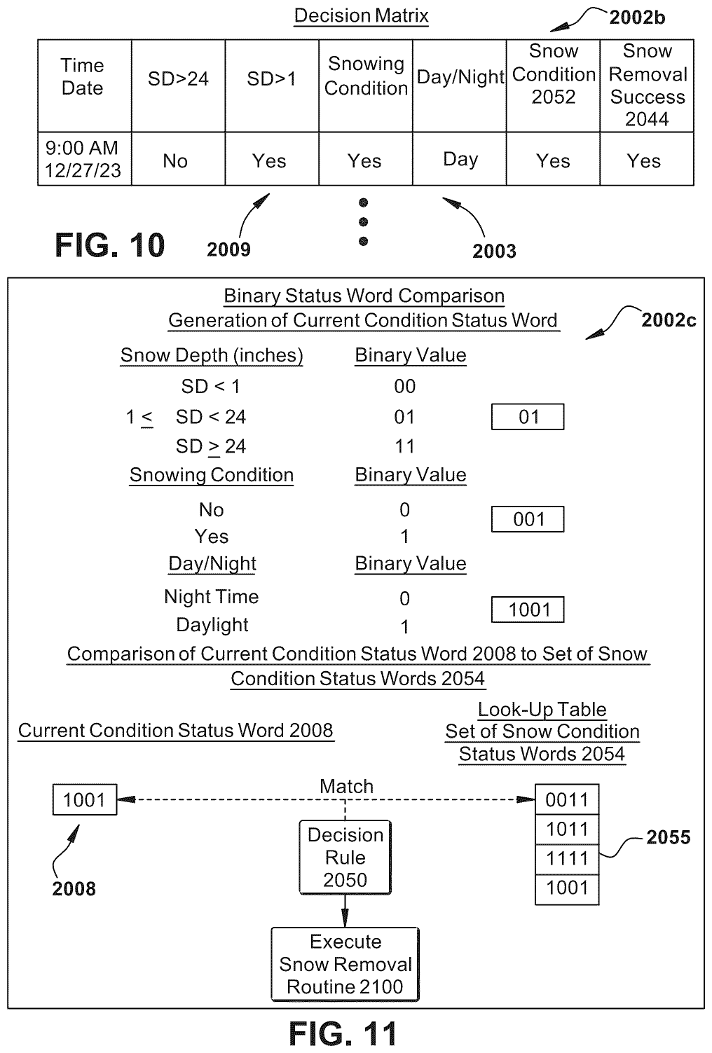

For purposes of illustrating the snow removal models 2002a, 2002b, 2002c, which are diagrammatically depicted in FIGS. 9-11, respectively, the following simplified example is presented. With respect to model 2002a (if-then decision tree), assume that the selected set of input variables 2001 includes: a) snow depth (SD) variable 2013, b) snowing condition (SF) variable 2028 (is snow currently falling? Yes=1, No=0); and c) day/night (D/N) variable 2034 (daylight hours=1, nighttime hours=0). Further assume that the if-then decision tree of the model 2002a is as follows: a) if SD≥24 in, then snow removal condition 2052; and b) if SD≥1 in. and SF=0 and D/N=1, then snow removal condition 2052; otherwise, no snow removal condition 2052. Further assume that assume that the current values for the set of three input variables 2005 are as follows: a) SD=5 in.; b) SF=0 (no snow falling); and c) D/N=1 (daylight hours). The current set of input variable values 2005 corresponds to a current condition status 2007. The decision rule 2050 utilizes the current set of input variable values 2005, as transformed by the input variable transformation function 2007, as required to generate the current condition status 2007, and applies the values to the if-then decision tree 2004. Based on the input variable values corresponding to the current condition status 2007, that decision rule 2050 concludes that the current condition status 2007 corresponds to the snow removal condition 2052. That is, since SD≥1 in. and SF=0 and D/N=1, then the current condition status 2007 corresponds to a snow removal condition 2052. The array controller 510 would communicate appropriate control signals to the plurality of solar tracker controllers 600 to execute the snow removal routine 2100. Subsequent to the execution of the snow removal routine 2100, the snow removal routine success variable 2044 is measured to determine the success/failure of snow removal routine 2100 with respect to removing accumulated snow from the upper surface 199 of the plurality of photovoltaic modules 190 of the solar tracker assembly 102. The snow removal routine success variable 2044 may utilize one or more of the following input variables to determine success/failure of the snow removal routine 2100: a) snow depth 2013, b) snow weight 2014, and/or c) snow reflectance 2016.

With respect to snow removal model 2002b (decision matrix or chart), the same selected set of input variables 2005 are utilized—SD=5 in., SF=0 (no snow falling) and D/N=1 (daylight hours), while a partial decision matrix 2003 is shown in FIG. 9. The selected set of current input data values 2005 are converted or mapped by the input variable transformation function 2006 into the set of Boolean values 2009 input to the decision matrix or chart 2003. The decision rule 2025 analyzes the set of Boolean values 2009 and determines if the current set of Boolean values 2009 corresponds to the snow removal condition 2052. The array controller 510 communicates appropriate control signals to the plurality of solar tracker controllers 600 to execute the snow removal routine 2100. Subsequent to the execution of the snow removal routine 2100, the snow removal routine success variable 2044 is measured to determine the success/failure of snow removal routine 2100 with respect to removing accumulated snow from the upper surface 199 of the plurality of photovoltaic modules 190 of the solar tracker assembly 102. The snow removal routine success variable 2044 may utilize one or more of the following input variables to determine success/failure of the snow removal routine 2100: a) snow depth 2013, b) snow weight 2014, and/or c) snow reflectance 2016.

With respect to snow removal model 2002c (binary status word comparison), the same selected set of input variables 2005 are utilized—SD−5 in., SF=0 (no snow falling) and D/N=1 (daylight hours). The input value of 5 in. for the snow depth variable 2013 is converted to a binary representation using the following mapping—SD<1 in. corresponds to the binary representation 00, 1 in.≤SD<24 in. corresponds to the binary representation 01, SD≥24 in. corresponds to the binary representation 11. The SD32 5 in. corresponds to the binary representation 01. The input value of 0 for the snowing condition variable 2028 corresponds to a binary representation 0 and the input value of 1 for the day/night variable 2034 corresponds to a binary representation 1. Thus, the current condition status word for the selected set of input variables 2005 and the current condition status 2007 is the current condition status word 2008 having a value of 1001. The current condition status word 2008 is compared to the set of snow condition status words 2055. The decision rule 2050 determines if there is a match between the current condition status word 2008 and any one of the set of snow condition status words 2055. If so, a snow removal condition 2052 is deemed to exist and the array controller 510 communicates appropriate control signals to the plurality of solar tracker controllers 600 to execute the snow removal routine 2100. Subsequent to the execution of the snow removal routine 2100, the snow removal routine success variable 2044 is measured to determine the success/failure of snow removal routine 2100 with respect to removing accumulated snow from the upper surface 199 of the plurality of photovoltaic modules 190 of the solar tracker assembly 102. The snow removal routine success variable 2044 may utilize one or more of the following input variables to determine success/failure of the snow removal routine 2100: a) snow depth 2013, b) snow weight 2014, and/or c) snow reflectance 2016.

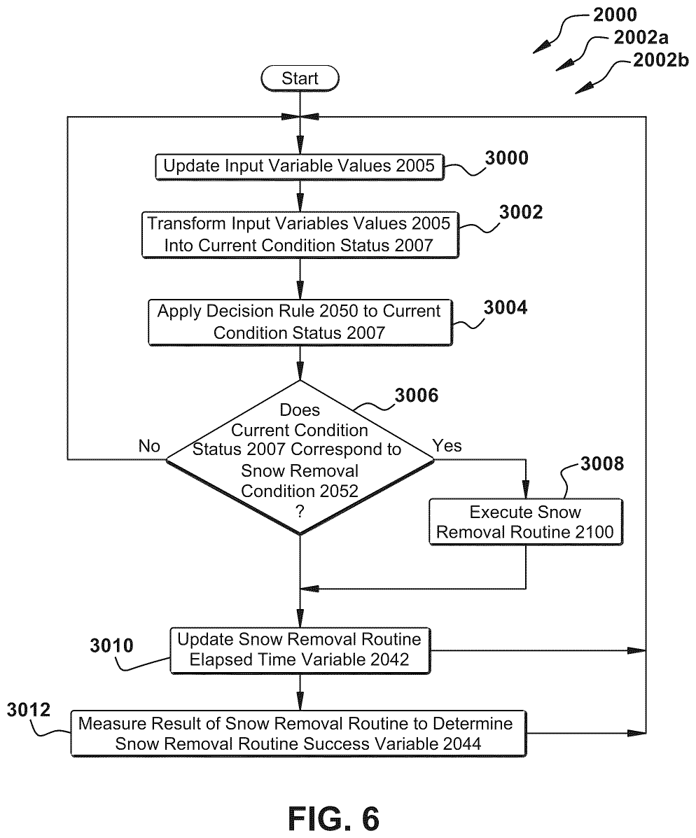

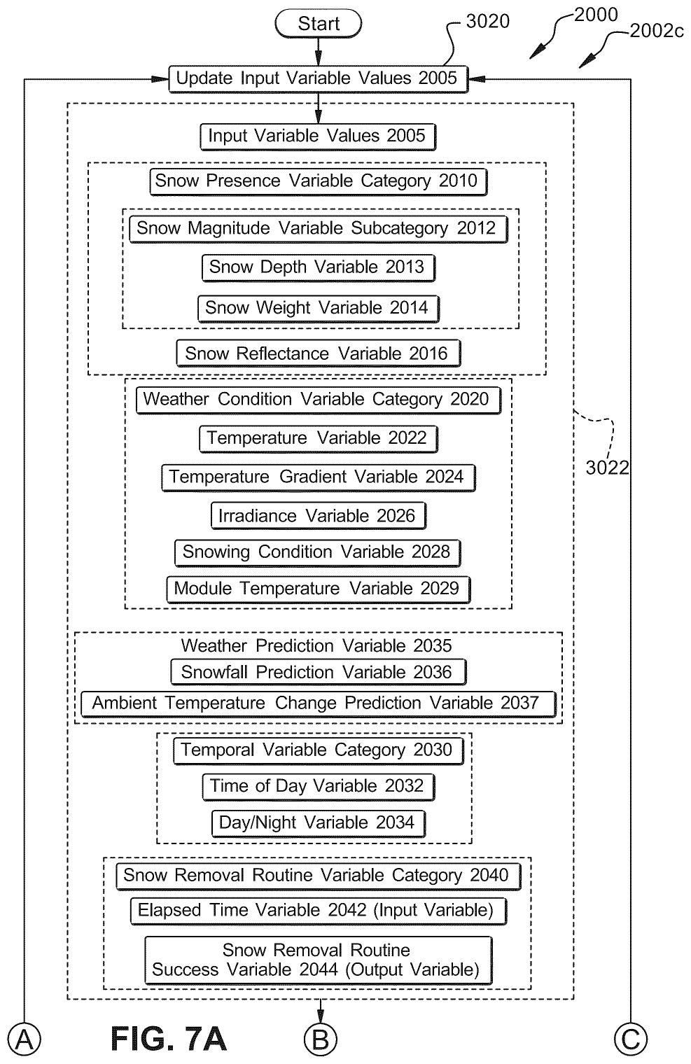

In FIGS. 6 and 7, a simplified flow diagrams of selected steps of example embodiments of the method of snow removal 2000 are presented. Specifically, FIG. 6 sets forth a simplified flow diagram for snow removal models 2002a, 2002b, while FIG. 7 sets forth a simplified flow diagram for snow removal model 2002c. Turning to FIG. 6, at step 3000, the selected set of input variable values 2005 is updated with current values for those variables. At step 3002, the input variable transformation function 2006 is applied, if necessary, transform the input variable values 2005 into a format that matches the format needed to determine if the current set of input variable values 2005 correspond to a snow removal condition 2052. Depending on the model and the variable values, a transformation of one or more variable of the current set of input variable values 2005 may or may not be required. In any event, after transformation, if required, the set of input variable values 2005 or the set of transformed input variable values 2005 is deemed to correspond to the current condition status 2007 which may be utilized by the decision rule 2050 to determine if the current values correspond to a snow removal condition 2052. Generally, in real world situations, a transformation will be required because output from a given sensor of the plurality of sensors 700 is likely to be, for example, an electrical output signal of the sensor, which may be a digital or analog signal, depending on the sensor. If a Boolean or binary variable value is required to be able to compare to a snow removal condition value 2052, it will be necessary to transform the electrical output signal of the sensor to a Boolean or binary variable value. The input variable transformation function 2006 performs this function so that the current condition status 2007 matches the required format of the snow removal condition 2052 thereby allowing the decision rule 2050 to be applied. As noted above, the input variable transformation function 2006 may be a component or part of the decision rule software or may be a stand-alone program.

At step 3004, the decision rule 2050 is applied to the current condition status 2007 and, at step 3006, the decision rule 2050 determines if the current condition status 2007 corresponds to a snow removal condition 2052. It should be understood that there may be a set of snow removal conditions 2052. That is, there may be multiple snow removal conditions 2052, as, for example, in the if-then decision tree model 2002a, where a SD≥24 in. or a combination of SD≥1 in. plus SF=0 plus D/N=1 both correspond to a snow removal condition 2052. If a snow removal condition 2052 is found by the decision rule 2050, at step 3008, the array controller 510 sends appropriate control signals to the plurality of solar tracker controllers 600 to execute the snow removal routine 2100. At step 3010, as one of the input variables is elapsed time variable 2042 between executions of the snow removal routine 2100, the snow removal routine elapsed time variable 2042 is reset to zero upon execution of the snow removal routine 2100. At step 3012, the success or failure of the snow removal routine 2100 is measured in terms of removal of accumulated snow from the upper surfaces 199 of the photovoltaic modules 190 of the solar tracker assembly 102. This measurement becomes the snow removal routine success variable value 2044. The snow removal routine success variable value 2044 may be measured by a surrogate such as, for example, has the snow depth variable value 2013, the snow weight variable value 2014, and/or the snow reflectance variable value 2016 been reduced to an acceptably low magnitude(s)? The snow removal routine success variable value 2044 is utilized by the machine learning process 2200 (shown as a simplified flow diagram at 2202 in FIG. 8), as previously described. If at step 3006, the decision rule 2050 determines that the current condition status 2007 does not match a snow removal condition 2052, the process returns to step 3000 where the input variable values 2005 are updated at the next periodic update (periodic updates may be made every ten minutes, for example).

FIG. 7 sets forth a simplified flow diagram for snow removal model 2002c. At step 3020, an updated set of input variable values 2005 is provided to the model 2002c. The set for input 2005 and output variables 2044 are shown within dashed line 3022. At step 3024, the input variable transformation function 2006 is applied to transform the current input variable values 2005 into, at step 3026, a binary current condition status word 2007. The current condition status word 2007 is a specific binary instance of the current condition status 2006. At step 3028, the decision rule 2050 compares the binary current condition status word 2007 to the set of binary snow condition status words 2054. If there is a match between the binary current condition status word 2007 and one of the set of binary snow condition status words 2054, at step 3030, the array controller 510 sends appropriate control signals to the plurality of solar tracker controllers 600 to execute the snow removal routine 2100. At step 3032, the snow removal routine elapsed time variable 2042 is reset to zero upon execution of the snow removal routine 2100. At step 3032, the success or failure of the snow removal routine 2100 is measured in terms of removal of accumulated snow from the upper surfaces 199 of the photovoltaic modules 190 of the solar tracker assembly 102. Success of removal of accumulated snow may be measured by, for example, has the snow depth variable value 2013, the snow weight variable value 2014, and/or the snow reflectance variable value 2016 been reduced to an acceptably low magnitude(s)? This measurement or measurements are the basis for the current snow removal routine success variable value 2044. The snow removal routine success variable value 2044 is utilized by the machine learning process 2200 (one example embodiment shown as a simplified flow diagrams at 2202 in FIG. 8), as previously described. At step 3028, the decision rule 2050 determines that the current condition status word 2008 does not match any of the set of snow condition status words 2054, no snow removal condition 2052 and the process returns to step 3020 where the input variable values 2005 are updated at the next periodic update (periodic updates may be made every 10 or 15 minutes, for example).

FIG. 8 sets forth a simplified flow diagram 2202 of a machine learning process 2200 used in conjunction with the method of snow removal 2200 to improve the performance of the method of snow removal 2200 based on analysis of success/failure of prior executed snow removal routines 2100 with respect to successfully removing accumulated snow from upper surfaces 199a of the plurality of photovoltaic modules 190 of the solar tracker assembly 102. At step 2210, a statistical analysis is employed which inputs the most recent prior current condition status words 2008, snow condition status words 2054 and corresponding snow removal routine success variable values 2044 to determine: a) at step 2212, a correlation between current condition status words 2008 and snow removal routine success variable values 2044; and b) at step 2214, a correlation between snow condition status words 2054 and snow removal routine success variable values 2044. Based on the degree of correlation found in step 2212, at step 2216, a score is assigned to the current condition status word 2008 as a measure of success in terms of execution of a successful snow removal routine 2100. Similarly, based on the degree of correlation found in step 2214, at step 2218, a score is assigned to the snow condition status word 2054 as a measure of success in terms of execution of a successful snow removal routine 2100.

As more and more snow removal routines 2100 are executed by the array controller 510 utilizing the snow removal method 2000, at step 2220, a historical database 2204 of values is created and an analysis is undertaken by the machine learning process 2200. The historical database analysis, at step 2222, based on the score generated at step 2216, characterizes each current condition status word 2008 as a good/bad snow removal success predictor. If at step 2222, a given current condition status word 2008 is a relatively good predictor of a successful snow removal routine 2100 then, at step 2224, the given current condition status word 2008 is maintained in the model, that is, the word 2008 remains associated with or corresponding to a snow condition status word 2054. On the other hand, if at step 2222, a given current condition status word 2008 is a relatively poor or bad predictor of a successful snow removal routine 2100 then, at step 2226, the word 2008 is removed from the model, that is, the word is no longer associated with or corresponding to a snow condition status word 2054.

The machine learning process 2200, at step 2230, utilizes the historical database 2204 and generates new current condition status words 2008 for testing and analysis. At step 2232, the newly generated current condition status words 2008 are associated with or correspond to snow condition status words 2054 such that the newly generated current condition status words 2008 can be tested and analyzed in terms of snow removal success. The feature of generating and testing new current condition status words 2008 advantageously makes the machine learning process 2200 dynamic, that is, machine learning process 2200 is capable of generating and testing new current condition status words, some of which will be found to be poor predictors of snow removal success, but some of which will prove to be very highly correlated with snow removal success. The new, highly predictive current condition status words 2008 will advantageously be incorporated into the snow removal models 2002a, 2002b, 2002c, as appropriate.

As used herein, terms of orientation and/or direction such as upward, downward, forward, rearward, upper, lower, inward, outward, inwardly, outwardly, horizontal, horizontally, vertical, vertically, distal, proximal, axially, radially, etc., are provided for convenience purposes and relate generally to the orientation shown in the Figures and/or discussed in the Detailed Description. Such orientation/direction terms are not intended to limit the scope of the present disclosure, this application and the invention or inventions described therein, or the claims appended hereto.

What have been described above are examples of the present disclosure/invention. It is, of course, not possible to describe every conceivable combination of components, assemblies, or methodologies for purposes of describing the present disclosure/invention, but one of ordinary skill in the art will recognize that many further combinations and permutations of the present disclosure/invention are possible. Accordingly, the present disclosure/invention is intended to embrace all such alterations, modifications, and variations that fall within the spirit and scope of the appended claims.

What is claimed is:

1. A method of snow removal from upper surfaces of photovoltaic modules mounted to pivoting tables of a plurality of solar tracker assemblies of a solar tracker installation based on a plurality of input variable values and application of a decision rule to determine if a snow removal routine is appropriate, the steps of the method comprising:
a) determining at least one current snow presence variable value associated with the solar tracker installation;
b) determining at least one other current variable value associated with the solar tracker installation selected from one or more of the following variable categories: 1) a weather condition variable category; 2) a temporal variable category; 3) a weather prediction variable category; and 4) a snow removal routine variable category;
c) applying the decision rule to determine if the at least one current snow presence variable value and the least one other current variable value correspond to a snow removal condition; and
d) if the decision rule determines that the at least one current snow presence variable value and the least one other current variable value correspond to a snow removal condition, executing the snow removal routine for a set of the plurality of solar tracker assemblies of the solar tracker installation.

2. The method of claim 1 wherein execution of the snow removal routine includes pivoting the respective tables of the set of the plurality of solar tracker assemblies though a predetermined angle of inclination path of travel.

3. The method of claim 1 wherein in step (a), determining at least one current snow presence variable value associated with the solar tracker installation includes measuring at least one variable value from the following variables: a snow magnitude variable and a snow reflectance variable.

4. The method of claim 3 wherein the snow magnitude variable may be either of the following: 1) a snow depth variable; and 2) a snow weight variable.

5. The method of claim 1 wherein in step (b), the weather condition variable category includes the following variables: 1) an ambient temperature variable; 2) a temperature gradient variable; 3) an irradiance variable; and d) snowing condition variable.

6. The method of claim 1 wherein in step (b), the temporal variable category includes the following variables: 1) time of day variable; and 2) day/night variable.

7. The method of claim 1 wherein in step (b), the weather condition prediction variable category includes the following variables: 1) snowfall prediction variable; and 2) ambient temperature change prediction variable.

8. The method of claim 1 wherein in the step (b), the snow removal routine variable category includes the following variables: 1) elapsed time since last execution of snow removal routine variable; and 2) snow removal routine success variable.

9. The method of claim 1 wherein step (c) includes the substep of applying a transformation function to the at least one current snow presence variable value and the at least on other current variable value to generate a current condition status word and wherein step (d) includes the substep of determining a set of snow condition status words that correspond to a snow removal condition and applying the decision rule to determine if the current condition status word corresponds to a snow condition status word of the set of snow condition status words.

10. The method of claim 1 wherein the step (a) of determining at least one current snow presence variable value includes measuring at least one snow magnitude variable selected from the following variables: 1) snow depth variable; and 2) snow magnitude variable.

11. The method of claim 1 wherein the step (b) of determining at least one other current variable value includes measuring at least one weather condition variable selected from the following variables: 1) an ambient temperature variable; 2) a temperature gradient variable; 3) an irradiance variable; and d) a snowing condition variable and further includes determining an elapsed time variable corresponding to an elapsed time since last execution of the snow removal routine for the set of the plurality of solar tracker assemblies of the solar tracker installation.

12. The method of claim 9 wherein the method further includes the step (e) of updating the set of snow condition status words that correspond to a snow removal condition based on an analysis of a correlation between previous snow condition status words corresponding to a snow removal condition and corresponding snow removal routine result variable values.

13. The method of claim 9 wherein the method further includes the step (e) of updating what variables should be included in a current condition status word based on an analysis of a correlation between previous current condition status words corresponding to a snow condition status words and corresponding snow removal routine success variable values.

14. A method of snow removal from upper surfaces of photovoltaic modules mounted to pivoting tables of a plurality of solar tracker assemblies of a solar tracker installation utilizing a snow removal routine, execution of the snow removal routine based on a plurality of input variable values, the steps of the method comprising:
a) determining a snow depth variable value associated with the solar tracker installation, the snow depth variable value representative of a depth of accumulated snow on the upper surfaces of the photovoltaic modules;
b) determining at least one other current variable value associated with the solar tracker installation;
c) setting a lower threshold value and an upper threshold value, the upper threshold value being greater in magnitude than the lower threshold value;
d) applying a decision rule to determine if a snow removal condition exists:
1) the decision rule finding a snow removal condition exists if the snow depth variable value is equal to or greater than the upper threshold value regardless of a current value of the at least one other current variable value; and
2) the decision rule finding a snow removal condition exists if the snow depth variable value is equal to or greater than the lower threshold value and less than the upper threshold value and if the current value of the at least one other current variable value has a predetermined snow condition value; and
e) if the decision rule determines that a snow removal condition exists, executing the snow removal routine for a set of the plurality of solar tracker assemblies of the solar tracker installation.

15. The method of snow removal of claim 14 wherein the at least one other current variable value is a snowing condition variable having a value of zero if it is not currently snowing, and wherein in step (d), substep (2) the decision rule finding a snow removal condition exist if the snow depth variable value is equal to or greater than the lower threshold value and less than the upper threshold value and if the current value of the snowing condition variable value is equal to zero.

16. The method of snow removal of claim 14 wherein the at least one other current variable value is: i) a snowing condition variable having a value of zero if it is not currently snowing and ii) a day/night variable having a value of one if it is daytime, and wherein in step (d), substep (2), the decision rule finding a snow removal condition exists if:
i) the snow depth variable value is equal to or greater than the lower threshold value and less than the upper threshold value; ii) the current value of the snowing condition variable value is equal to zero; and iii) the current value of the day/night variable is equal to one.

17. The method of snow removal of claim 14 wherein the at least one other current variable value is: i) a snowing condition variable having a value of zero if it is not currently snowing, ii) a day/night variable having a value of 1 if it is daytime, and iii) an elapsed time variable having a value equal to an elapsed time since the previous execution of the snow removal routine, and wherein in step (d), substep (2), the decision rule finding a snow removal condition exists if: i) the snow depth variable value is equal to or greater than the lower threshold value and less than the upper threshold value; ii) the current value of the snowing condition variable value is equal to zero; iii) the current value of the day/night variable is equal to one; and iv) the current value of the elapsed time variable is equal to or greater than a predetermined time period.

18. A method of snow removal from upper surfaces of photovoltaic modules mounted to pivoting tables of a plurality of solar tracker assemblies of a solar tracker installation based on a plurality of input variable values and application of a decision rule to determine if a snow removal routine is appropriate, the steps of the method comprising:
a) determining at least two current variable values associated with the solar tracker installation selected from one or more of the following variable categories: 1) a weather condition variable category; 2) a temporal variable category; 3) a weather prediction variable category; and 4) a snow removal routine variable category;
b) applying a transformation function to the at least two current variable values to generate a current condition status word;
c) applying the decision rule to determine if the current condition status word corresponding to a snow removal condition;
d) if the decision rule determines that the current snow condition status word corresponds to a snow removal condition, executing the snow removal routine for a set of the plurality of solar tracker assemblies of the solar tracker installation; and
e) updating what variables should be included in a current condition status word based on an analysis of a correlation between previous current condition status words corresponding to a snow removal condition and corresponding snow removal routine result variable values.

19. The method of snow removal of claim 18 wherein, in step (d), the decision rule compares the current condition status word to a set of snow condition status words and if the current condition status word matches any snow condition status word of the set of snow condition status words, a snow removal condition is determined.

20. The method of snow removal of claim 18 wherein in step (e), updating further includes updating the set of snow condition status words based on an analysis of a correlation between previous current condition status words corresponding to a snow removal condition and corresponding snow removal routine result variable values.

21. A method of snow removal from upper surfaces of photovoltaic modules mounted to pivoting tables of a plurality of solar tracker assemblies of a solar tracker installation based on a plurality of input variable values and application of a decision rule to determine if a snow removal routine is appropriate, the steps of the method comprising:
a) determining at least two current variable values associated with the solar tracker installation selected from one or more of the following variable categories: 1) a weather condition variable category; 2) a temporal variable category; 3) a weather prediction variable category; and 4) a snow removal routine variable category;
b) applying a transformation function to the at least two current variable values to generate a current condition status word;
c) applying the decision rule to determine if the current condition status word corresponding to a snow removal condition; and
d) if the decision rule determines that the current snow condition status word corresponds to a snow removal condition, executing the snow removal routine for a set of the plurality of solar tracker assemblies of the solar tracker installation.

22. A method of snow removal from upper surfaces of photovoltaic modules mounted to pivoting tables of a plurality of solar tracker assemblies of a solar tracker installation located on a solar tracker installation site utilizing a snow removal routine, the steps of the method comprising:
a) setting a snow depth threshold value;
b) periodically determining a snow depth variable value representative of a depth of accumulated snow on the upper surfaces of the photovoltaic modules of one or more of the plurality of solar tracker assemblies;
c) periodically determining a snowing condition variable value representative of whether or not it is currently snowing at the solar tracker installation site;
d) applying a decision rule to determine if a snow removal condition exists, the decision rule determining a snow removal condition exists if the snow depth variable value is equal to or greater than the snow depth threshold value and if the snowing condition variable value has a value indicating that it is not currently snowing at the solar tracker installation site; and
e) if the decision rule determines that a snow removal condition exists, executing the snow removal routine for a set of the plurality of solar tracker assemblies of the solar tracker installation.

23. The method of snow removal of claim 22 wherein the set of the plurality of solar tracker assemblies includes all of the plurality of solar tracker assemblies of the solar tracker installation.

24. The method of snow removal of claim 22 wherein the snow depth threshold value includes two values, a lower snow depth threshold value and an upper snow depth threshold value and wherein the decision rule determines a snow removal condition exist if: i) the snow depth variable value is equal to or greater than the upper snow depth threshold value; or ii) the snow depth variable value is equal to or greater than the lower snow depth threshold value and less than the upper snow depth threshold value and if the snowing condition variable has a value indicating that it is not currently snowing at the solar tracker installation site.

25. The method of snow removal of claim 22 wherein step (d) includes the substep of applying a transformation function to the snow depth variable value and the snowing condition variable value to generate a current condition status word and further includes the substep of determining a set of snow condition status words that correspond to a snow removal condition and applying the decision rule to determine if the current condition status word corresponds to a snow condition status word of the set of snow condition status words.
